(19) United States
(12) Patent Application Publication
(10) Pub. No.: US 2006/0041478 A1
(43) Pub. Date: Feb. 23, 2006

(54) Universal network market system

(76) Inventor: Zhiliang Zheng, Sunnyvale, CA (US)

Correspondence Address: PERKINS COIE LLP, P.O. BOX 2168, MENLO PARK, CA, 94026, US

(21) Appl. No.: 11/206,512

(22) Filed: Aug. 18, 2005

Related U.S. Application Data
(63) Continuation-in-part of application No. 11/142,516, filed on May 31, 2005.
(63) Continuation-in-part of application No. 11/142,510, filed on May 31, 2005.
(63) Continuation-in-part of application No. 11/141,781, filed on May 31, 2005.
(63) Continuation-in-part of application No. 11/142,634, filed on May 31, 2005.
(60) Provisional application No. 60/576,049, filed on Jun. 1, 2004.
(60) Provisional application No. 60/590,998, filed on Jul. 26, 2004.
(60) Provisional application No. 60/602,688, filed on Aug. 17, 2004.
(60) Provisional application No. 60/622,659, filed on Oct. 27, 2004.
(60) Provisional application No. 60/623,980, filed on Nov. 1, 2004.
(60) Provisional application No. 60/669,209, filed on Apr. 7, 2005.
(60) Provisional application No. 60/694,319, filed on Jun. 27, 2005.

(51) Int. Cl. G07G 1/14

(52) U.S. Cl. 705/14

(57) ABSTRACT

A method and system for selecting and presenting advertisements and promotions to a user based on one or more tasks that is of interest to the user is disclosed.

### CROSS REFERENCES TO RELATED APPLICATIONS

This application is a continuation-in-part of U.S. patent application Ser. No. 11/142,516, filed on May 31, 2005, U.S. patent application Ser. No. 11/142,510, filed on May 31, 2005, U.S. patent application Ser. No. 11/141,781, filed on May 31, 2005, U.S. patent application Ser. No. 11/142,634, filed on May 31, 2005, Provisional Application No. 60/576,049, filed on Jun. 1, 2004, Provisional Application No. 60/590,998, filed on Jul. 26, 2004, Provisional Application No. 60/602,688, filed on Aug. 17, 2004, Provisional Application No. 60/622,659, filed on Oct. 27, 2004, Provisional Application No. 60/623,980, filed on Nov. 1, 2004, Provisional Application No. 60/669,209, filed on Apr. 7, 2005, and Provisional Application No. 60/694,319, filed on Jun. 27, 2005, the benefit of the earlier filing dates are hereby claimed under 35 U.S.C. 119(e), and which applications are all hereby incorporated by reference in their entirety.

### TECHNICAL FIELD

Embodiments described herein relate generally to electronic shopping and, more particularly, to selecting and presenting targeted advertising to a user based on the users interest in one or more tasks.

### BACKGROUND

Advertising using traditional media, such as television, radio, newspapers and magazines, is known. Advertisers have used such types of media to reach a large audience with their advertisements. To reach a more responsive audience, advertisers have used demographic studies. For example, advertisers may use broadcast events such as football games to advertise beer and action movies to a younger male audience. However, even with demographic studies and entirely reasonable assumptions about the typical audience of various media outlets, advertisers recognize that much of their ad budget is simply wasted because the target audience is not interested in the advertisements or promotional information that the target audience is receiving.

Interactive media, such as the Internet, has the potential for better targeting of advertisements. For example, some websites provide an information search functionality that is based on query keywords entered by the user seeking information. This user query can be used as an indicator of the type of information of interest to the user. By comparing the user query to a list of keywords specified by an advertiser, it is possible to provide some form of targeted advertisements to these search service users. The effectiveness may be limited to sites where the user enters a search query to indicate their topic of interest.

However, traditional advertising methods may not meet a user's particular needs. For example, traditional advertising methods do not identify advertisements related to tasks that help a user, which tasks are based on demographic information on the user and the user's specified needs. The traditional methods do not provide expert solutions directed to an identified task of interest and do not select promotions related to the tasks associated with the expert solutions for presentation to the user.

### BRIEF DESCRIPTION OF THE DRAWINGS

FIG. 1 is a block diagram illustrating an environment in which embodiments described herein may be implemented;

FIG. 2 is a block diagram illustrating a universal network market system in accordance with certain embodiments;

FIG. 3 is a block diagram of an architecture for implementing embodiments of the universal network market system;

FIG. 4 is a flowchart of a process for providing targeted advertising in accordance with certain embodiments;

FIG. 5 is a block diagram of an illustrative categorized shopping list that may be used as a shopping organizer in accordance with certain embodiments;

FIG. 6 is an illustrative “My Immediate” shopping list of a representative buyer in accordance with certain embodiments;

FIG. 7 is an illustrative buyer's service request list in accordance with certain embodiments;

FIG. 8 is an illustrative item requirement list in accordance with certain embodiments;

FIG. 9 presents an illustrative shopping expert that may be presented to a user by a universal network market system in accordance with certain embodiments;

FIG. 10 shows illustrative tables that may be used to provide customer-oriented advertisements in accordance with certain embodiments;

FIG. 11 is an exemplary timing-critical advertisement that may be presented to a buyer in accordance with certain embodiments;

FIG. 12 is an illustration of a table that may be used by a universal network market system to conduct a direct selling event in accordance with certain embodiments;

FIG. 13 is an illustrative Customer-Specific Advertisement Magazine in accordance with certain embodiments;

FIG. 14 is an example of a table that may be used to generate ID-related coupons in accordance with an illustrative embodiment;

FIG. 15 is a table that may be used to afford an efficient advertisement reward referral system in accordance with certain embodiments;

FIG. 16 is an example of an illustrative Linked Raking System in accordance with certain embodiments;

FIG. 17 is an example of a Menu/installation Software table that may be afforded by a universal network market system in accordance with certain embodiments;

FIG. 18 is an exemplary browser/toolbar for a universal network market system in accordance with certain embodiments;

FIG. 19 is a flowchart of a process for organizing items of interest for presentment to a user in accordance with certain embodiments;

FIG. 20 is a flowchart of a process for presenting advertising alert to a user based on items of interest to the user in accordance with certain embodiments;

FIG. 21 is a flowchart of a process for purchasing items in accordance with certain embodiments;

FIG. 22 is a schematic diagram of an illustrative network system in accordance with certain embodiments; and

FIG. 23 is a schematic diagram of a representative hardware environment in accordance with certain embodiments;

FIG. 24 is a flowchart of a process for allowing a user to refer items to third parties in accordance with certain embodiments;

FIG. 25 is a flowchart of a process for linked ranking in accordance with certain embodiments;

FIGS. 26A-26D illustrate a process for presenting targeted promotions to a user based on items selected by the user, in accordance with certain embodiments;

FIGS. 27A-27B illustrate a process for presenting targeted promotions to a user based on a user's interest in certain tasks, in accordance with certain embodiments;

FIG. 28 is a flowchart that illustrates a process for receiving and presenting expert solutions to a user, in accordance with certain embodiments; and

FIG. 29 is an exemplary expert platform, in accordance with certain embodiments.

### DETAILED DESCRIPTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments, of the invention.

In general, embodiments of a universal market network system that can provide expert criteria for assisting a shopper and provide a means for permitting shoppers to track and organize shopping items are described. Embodiments of the universal market network system may also be capable of providing users with time-critical targeted advertising.

Methods and computer program products for organizing items of interest for presentment to a user are described. Information is obtained about one or more items of interest to a user. For each item, the obtained information includes information identifying the item and information about one or more characteristics of the item. For each item, the user is permitted to assign the item to one or more categories of need. The items are categorized into a plurality of lists according to the assigned categories of need. The plurality of lists are presented to the user so that the user can review items assigned to the same category of need in the list associated with the given category of need.

In one embodiment, a network may be utilized to obtain the information from the user and present the lists to the user. In another embodiment, the information may be obtained from the user by presenting, to the user, an interface capable of receiving input about the items from the user. In such an embodiment, the interface may present a plurality of items from which the user can select the items of interest. The interface may also be capable of receiving textual input from the user.

In one embodiment, the plurality of lists may include a general list that includes all of the items obtained from the user. In another embodiment, the characteristics may be defined by the user. In a further embodiment, the categories of need may include a category of items needed immediately, a category of items needed regularly, and a category of items of general interest.

In one embodiment, the information about one or more characteristics of the item includes frequency information about a frequency that the item is purchased by the user, and wherein frequency information is used to generate a reminder notice to the user. The frequency information may be obtained from items associated with a category of regularly needed items. As an option, the generation of the reminder notice may include adding an entry for the item into a reminder list.

In one embodiment, information may be collected about the items from one or more third party sites. In such an embodiment, links to the collected information may be included in at least one of the lists presented to the user. In another embodiment, evaluation information relating to the items may be collected. The collected evaluation information that is associated with a given item obtained from the user may then be presented to the user to provide advice to the user regarding the item. In such an embodiment, the user may also be queried for information relating to the user's interest in the given item. This information relating to the user's interest may then be used to generate a recommendation to the user about the item.

In another implementation, embodiments are described for a system, method and computer program product for presenting advertising alerts to a user based on items of interest to the user where information is obtained about one or more items of interest to the user. For each item, the user is permitted to select whether to receive advertising alerts relating to the item. Subsequently, a determination may be made as to whether a promotion is available for an item selected to receive advertising alerts. When a promotion is available, the user is presented with an advertising alert about the promotion.

In one embodiment, the user may be permitted to specify criteria for selecting promotions. In such an embodiment, the determination may further include a determination as to whether the available promotion satisfies at least a portion of the criteria specified by the user so that the advertising alert may be presented for promotions that satisfy the portion of the specified criteria.

In one embodiment, the advertising alert may be transmitted to a wireless device of the user. In another embodiment, the advertising alert may be presented to the user via a network.

In a further embodiment, the determination may further include registering a seller in order to permit the seller to submit promotions for goods and services associated with the seller. In such an embodiment, a determination may be made as to whether any of the submitted promotions of the seller matches one of the items selected by the user to receive advertising alerts so that the advertising alert presented to the user may be associated with at least one submitted promotion that was determined to match one of the items submitted by the user. As an option, the user may also be permitted to contact the seller via a network.

In one embodiment, one or more third party sites may be searched for promotions that will expire within a predetermined amount of time. A determination may be made as to whether the promotion is directed to one or more of the items obtained from the user. The user may then be presented with an advertising alert relating to the promotion. In such an embodiment, the one or more items to which the promotion is related can include at least one item for which the user chose not to receive advertising alerts.

In one embodiment, one or more third party sites may be searched for new update information associated with at least one item obtained from the user. The user may then be presented with an alert that indicates the availability of the new update information. In another embodiment, a magazine may be generated that contains the promotions determined to be available, and wherein the magazine is presented to the user. As an option, the magazine may comprise an online magazine. The magazine may also contain identifiers associated with the promotions included in the magazine. The magazine may further include promotions for additional recommended items that are selected based on an association to the items for which promotions are determined to be available.

In one embodiment, the information for each item may further include information about one or more characteristics of the item. In such an embodiment, the determination of whether a promotion is available may include searching for promotions that relate to the information about the one or more characteristics of the item. In another embodiment, the user may be permitted to assign each item to one or more categories of need so that the items may be organized into a plurality of lists according to the assigned categories of need. The plurality of lists may then be presented to the user so that the user can review the items assigned to the same category of need in the list associated with the given category of need. In such an embodiment, the advertising alert may be presented in the list(s) to which the item is assigned.

In one embodiment, the promotion that is determined to be available may require an identifier associated with the user to be disclosed when redeeming the promotion. In another embodiment, the user may forward the advertising alert to a third party. If and when the third party accesses the promotion utilizing the advertising alert, the user may then be assigned a credit for the access by the third party with the value of the credit being assigned based on at least a degree of relatedness of the third party to the user.

In a further implementation, embodiments of a system, method and computer program product for purchasing items are described where information is obtained about one or more items of interest to a plurality of users. For each item, the number of users that identify the item as an item of interest is determined. Negotiations are conducted with a seller of the item for a discounted price for a number of items at least equal to the number of users determined to identify the item. A coupon is then sent to the users that identify the item as an item of interest. The coupon permits the purchase of the item at the negotiated discounted price.

In one embodiment, the determination of the number of items may be performed for a set of the items of interest that are assigned by the users to a category of items needed immediately by the users. In another embodiment, the items of interest for each user may be organized into a plurality of lists according to assigned categories of need so that the lists can be presented to the given user. The user can then review items assigned to the same category of need in the list associated with the given category of need. In such an embodiment, the sent coupon may be presented in the lists that have the item of interest. In a further embodiment, the coupon may be sent to a wireless device of the users that identify the item as an item of interest. In another embodiment, the coupon may be sent via a network. In other embodiments, a physical coupon may be mailed to the user using the postal system.

In one embodiment, at least one user may forward the coupon to a third party. If and when the third party redeems the coupon, each referring user may be assigned a credit for the redemption of the coupon by the third party with the value of the credit being assigned based on the degree of relatedness of the third party to the given user. In another embodiment, reviews that are made by the users may be collected about at least one item. In such an embodiment, at least a portion of the reviews may have been made by users that are separated from each other by a predetermined degree of relatedness or less. A first rating may then be presented for the item based on the portion of reviews that are made by the users separated from each other by the predetermined degree of relatedness. A second rating may also be presented for the item based on all of the reviews. The second rating may be presented adjacent the first rating.

In yet another implementation, embodiments of a system, method and computer program product for finding customer oriented Ads are described where a buyer's information is obtained about one or more items of interest to the buyer. For each item, the buyer's information may comprise information identifying the item and information about one or more characteristics of the item. Seller's information is then selected to present to the buyer according to the buyer' information. The seller's information may comprise information identifying the item, Ads, promotions, coupons, product release, information about one or more characteristics of the item.

In one embodiment, the selected seller's information may be presented to the buyer. In such an embodiment, the presentment can be in the form of text, print, audio, and video, data stream, icons or graphics images with links to host web servers. In another implementation, the presentment and the act of receiving can be through the Internet, telephone, e-mail, TV, interactive TV, interactive voice response (IVR), voice-over IP, call centers, store fronts, ATM, kiosks, any hand held device and other platform that can conduct business. In a further implementation, the presentment can be in the form of serving to the buyer the selected seller's information. In yet another implementation, the presentment can be in the form of sending to the buyer the selected seller's information.

In one embodiment, selected seller's information, or the buyer's information, or all of seller's information may be stored in a database. In one implementation, the database may be stored centrally on a network device. In another implementation, the database may be stored locally on a network device. In a further implementation, the database may be stored distributively on network devices.

In one embodiment, a seller's desire—which is the information about items a seller wish to sell or serve—may be received. In such an embodiment, the seller's desire may be treated as seller's information. In another embodiment, the acts of selecting the seller's information may be based on the buyer's information available on the database, either while the buyer is using the network device or is not using the network device, or is offline. In a further embodiment, seller's information may be selected locally. In yet another embodiment, seller's information may be selected distributively over the network. In yet another embodiment, seller's information may be selected centrally.

In one embodiment, a computer or computing machine may select the seller's information. In another embodiment, a human being may select the seller's information manually. In a further embodiment, an user-friendly shopping organizer (e.g., a shopping list) may be provided.

According to certain other embodiments, tasks that are of interest to the user are identified, and expert solutions that are associated with the identified tasks of interest are presented to the user for selection. Products and services (items of interest) are offered to the user based on the user's selected expert solution or identified tasks. When the user selects the offered items of interest, such selected items can be used to select relevant advertisements and promotions for presentment to the user. In certain implementations, cross-selling and up-selling promotions and advertisements can be selected for presentment to the user based on the identification of sub-tasks and/or other tasks related to the tasks of interest to the user.

### Environment and Architecture

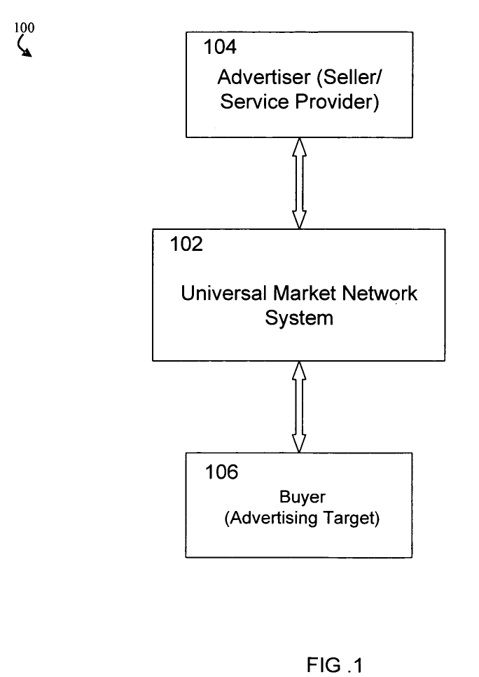

FIG. 1 is a block diagram illustrating an exemplary environment 100 in which embodiments described herein may be implemented. The exemplary environment comprises a universal market network system 102 that is coupled to one or more advertisers 104 and one or more advertising targets or buyers 106. In FIG. 1, an advertiser 104 may comprise a seller or service provider, and/or a party that provides advertising services on behalf of a seller or service provider, and/or an agent authorized to act on the advertiser's behalf. A seller may also be referred to herein as an advertiser. The universal network market system 100 may also be referred to herein as a shopping and advertising system. The universal network market system 100 provides an interface between the advertisers 104 (and thus sellers/service providers) and potential buyers 106 of goods and services.

The advertisements associated with advertiser 104 may exist in a variety of forms ranging from standard print advertisements, online advertisements, audio advertisements, audio/visual advertisement, or any other type of sensory message.

Promotions are used to advertise products/goods and services, promote events or present other commercial or non-commercial information. Advertisements may comprise any type of advertisements, promotions, coupons, bonus points, special offers, information on product releases, information on new products, and product updates. Advertisements may also be referred to herein promotions.

A product may include physical products, any commercial or non-commercial services that a company or individual can provide. An item may include physical products, any commercial or non-commercial services that a company or individual can provide, events such as meetings, a desired task (e.g. skiing or acts associated with a product release), advertisements and so on. An item may possess characteristics (e.g. BMW car, new car, old car). The characteristics of an item can be used to categorize the item.

Generally, promotions are used for advertising goods or services, and promote events. A promotion is directed to one or more items (e.g. $500 of DELL laptop computer, the promotion is directed to laptop, computer, or DELL laptop computer).

For a given item, one or promotions or advertisements may “match” with the item. A “match” need not be an exact match. Instead, a match may be an indication of a relatively high degree of similarity, and/or a predetermined degree of similarity, and/or a predetermined degree of relatedness. The predetermined degree of similarity can be based on the category (e.g. category “food”), the characteristics (e.g., tall people), or other relationships. For example, printer ink may be considered a related item of the printer. “Matched” items can include related items.

Promotions associated with related items can be considered related promotions associated with the item of interest. For example, if a Dell Printer is an item of interest, then the promotion, “$500 off Printer Ink” is a relative promotion associated with the item Dell Printer. Similarly, any promotions on Dell Printers are considered related promotions of printer ink.

The “highly” matched promotions (those promotions closely related to the item) of a item specified by a user may be presented to the user directly. The “less” matched promotions or related promotions (e.g. crossing-selling opportunities) can be presented to the user in the form of a recommended advertisement.

### Business Operation

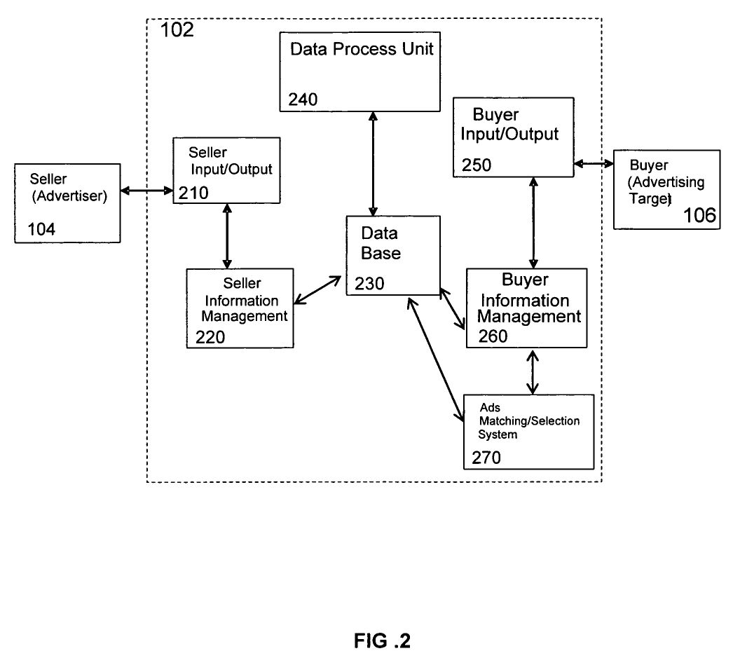

FIG. 2 is a block diagram illustrating a universal network market system 102 in accordance with certain embodiments. The universal network market system 102 may provide one or more of the following functions/services: market system customer-oriented advertisements, finding timing-critical advertisements, direct selling with minimum inventory, providing customer-specific advertisement magazines, ID-related coupons, an efficient advertising reward referral system, and a linked rating system. To carry out such functions/servers, the universal network market system 102 may include (as shown in FIG. 2) a seller/advertiser input/output (I/O) component 210 for interfacing with one or more sellers/advertisers 104, a seller/advertiser management component 220, one or more databases 230, one or more data processing units 240, a buyer/advertising target management component 260, a buyer/advertising target I/O component 250 for interfacing with one or more buyers/advertising targets 106, and a system 270 for selecting advertisements. The buyer/advertising target management component 260 also may include a shopping expert and a shopping list. The advertisement selection system/component 270 may be used for implementing various advertisement selection-related features of the universal network market system 102. The functions and services of the universal network market system may be provided by utilizing the buyer/advertising management component 260, data processing unit 240, and seller/advertiser management component 220 and the advertisement selection component 270.

The universal network market system may be utilized to build a company that has connections with, for example, commercial/merchant companies and financial companies. Such companies can use the universal market system to provide products and services to individual persons or other companies. Such services may include, for example, providing shopping experts, providing shopping lists, providing customer-oriented advertisements, and permitting direct selling with minimum inventory for any product.

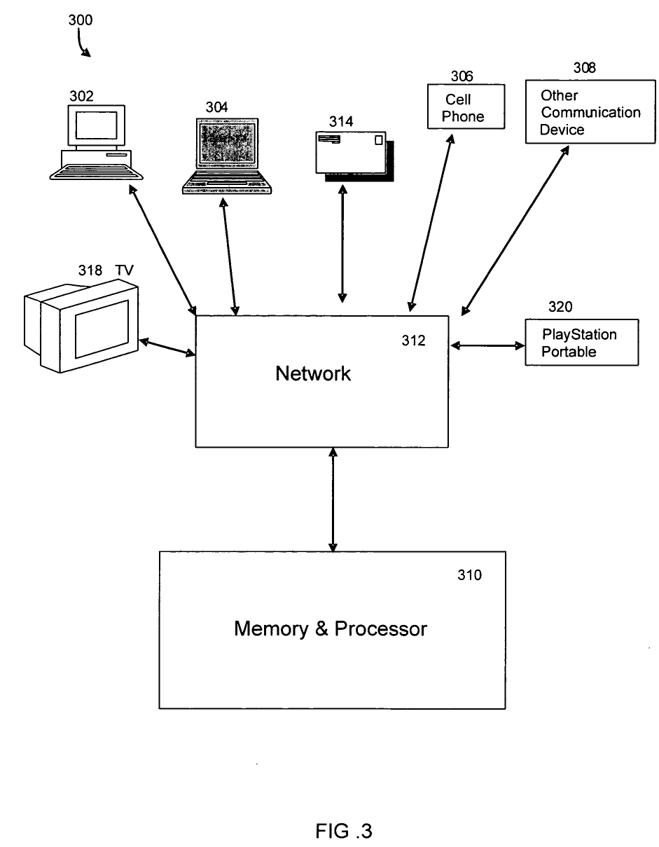

FIG. 3 is a block diagram of a sample architecture 300 for implementing embodiments of the universal network market system. As shown in FIG. 3, the architecture 300 may includes multiple client devices 302, 304, 306, 308, 318, 320 or clients, a server device 310 and a network 312. The buyer and sellers of the universal network market system may be implemented as client devices while the universal network market may be implemented by the server. Client devices may comprise computers, handheld devices, phone cameras, or any other computing devices that can obtain access to the server via the network. By using a client device, a user can view shopping items (e.g., products/services) and insert selected products/services of interest into one or more electronic shopping lists.

Client devices may also include bar code scanning components to permit the scanning and reading of bar codes. In a mobile phone implementation of a client, the bar code scanning component may be implemented in part using a digital cameral component of the mobile phone. In such an implementation, the bar code component may be used to read bar codes presented with the shopping items in order to obtain information about the product/service of interest and that can be displayed to the shopper on a visual display component of the client device (e.g., information may pop-up automatically over a display of a mobile phone). Items that are displayed on the client device may then be selected by the shopper and moved into one or more electronic shopping lists. In certain implementations where radio frequency identification (RFID) technology is used, a client device may include a component capable of reading RFIDs attached to a product/service. The information read from the RFID may then be used to obtain information corresponding to the selected product/service. Such information can then be displayed to the shopper so that the shopper can select products/services for inclusion in the shopper's electronic shopping list.

The universal network market system may use a variety of communication channels such as, for example, the Internet, telephone networks, e-mail, television, Interactive television, interactive voice response (IVR), voice-over IP, call centers, store fronts, ATMs, kiosks, hand held devices and any other platform used for conducting business.

In one embodiment, the universal network market system may be implemented distributively on the client devices and servers over the network. In another embodiment, the universal network market system may be implemented locally on the client devices in the network.

### Operation

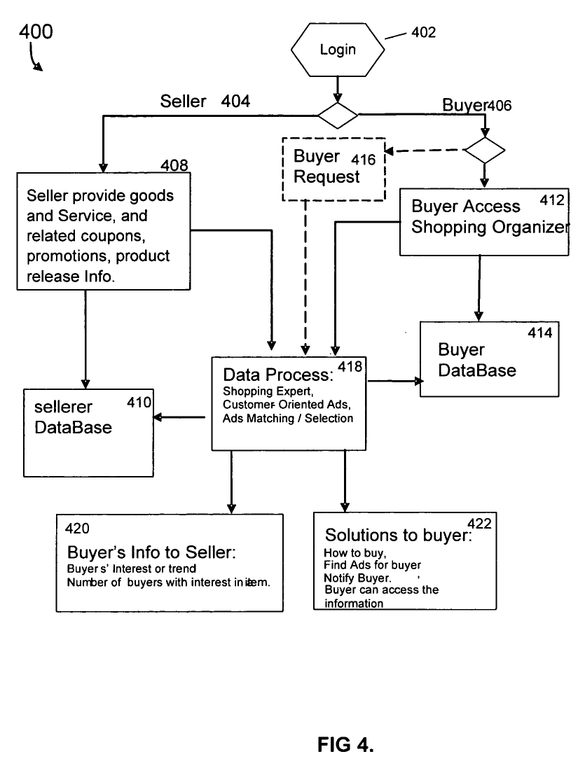

FIG. 4 is a flowchart of a process 400 for providing targeted advertising in accordance with certain embodiments. Upon user login 402, the path taken through the process is dependent on whether the client is a seller/advertiser, in which case the seller path 404 is followed, or a buyer/advertising target in which case the buyer path 406 is followed.

If the seller path 404 is followed, then in block 408, the seller provides information to the universal network marketing system about goods and/or services the seller wishes to sell and/or advertise, coupons for the goods/service, promotion-related information, and product release related information. This information may then be stored in a seller database of the universal network market system (see block 410). If the buyer path 406 is followed, then in block 412, the buyer may access a shopping organizer/shopping list to provide information to and obtain information from the universal network market system. Information provided by the buyer may be stored in a buyer database of the universal network market system (see block 414). With either path 404, 406, information provided to the universal network market system (including, e.g., buyer requests 416) may be subject to one or more processes/functions (e.g., shopping expert functions, customer-orientated advertising functions, etc.) of the universal network market system in block 418 so that information about a buyer can be provided to a seller (see block 420) and information and solutions (fro example, how to buy or find advertisements, etc.) from the universal network market system can be provided to a buyer (see block 422). By using process 400, a seller can, for example, login to the system, get access to the shopping list/shopping organizer, and then use the shopping expert, customer-oriented advertisements and other services/functions of the universal network market system.

### Interface

Through a communication channel, a user can build a specific account with the universal network market system. An account may have a user-ID associated with it. If the client is a buyer/advertising target, then the buyer can login to the universal network market system using the associated user-ID to access the account and functionality/services of the universal network market system such as the shopping expert, the shopping list/shopping organizer, and customer-oriented-advertisements. The buyer can also obtain help from the universal network market system on how to choose a product/service. For example, a buyer may provide the universal network market system with a list of products/services that the buyer is interested in and the universal network market system can then find the right product, brand, company for the buyer.

Depending on the implementation, buyers can provide the universal network market system with their personal information such as mailing address, billing information, and email addresses in order to help enhance the buyer's experience with the universal network market system. However, the universal network market system can be implemented so that buyers can choose not to provide some or all of their personal information to the universal network market system and still obtain access to their accounts and functions/services of the universal network market system. For further privacy control, an account may be identified only by an ID, for example.

Advertisements distributed by the universal network market system may be first routed to the universal network market system and then sent to a buyer's e-mail address or other address in such a manner that such distribution can be quickly disabled upon the buyer's request. Thus, a buyer can choose to block or receive any seller's advertisements.

A seller can also build an account in the universal network market system and provide the universal network market system with information about a variety of things including goods and services that the buyer wishes to sell/provide and advertise, the types of advertisements, coupons, product releases. Using this information, the universal network market system may then be able to identify prospective customers (e.g., buyers/advertising targets) for the buyer.

The universal network market system may also include functionality/components for checking other data sources (including the Internet/World Wide Web) for information related to the information about the buyers and/or sellers. Some exemplary information that may be collected includes, for example, information about other coupons offered by a seller as well as information about network browsing and shopping behavior of a buyer. The information collected from these other data sources may be provided to buyers and/or sellers depending on the service.

### Shopping List (Buying List/Selling List)

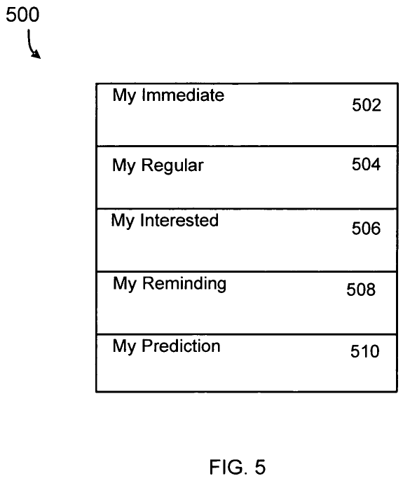

FIG. 5 is a block diagram of an illustrative categorized shopping list 500 that may be used as a shopping organizer in accordance with certain embodiments. The shopping list is more than just a service for tracking shopping items. Users can organize and manage their shopping items using the shopping organizer of the universal network market system. The shopping list is a place that a customer can keep track of whatever products/services that the customer is interested in obtaining or what the customer wants to purchase or use some time in the future. Buyers view items of interest and move selected items to their shopping list.

In one embodiment, a small command/link: “Into shopping list” may be displayed adjacent goods and services presented to a customer so that the customer can review and select items by selection of the command. Thus, a buyer can simply click on “Into shopping list” adjacent a product/service to put the product/service into the buyer's shopping list. Inside the shopping list, buyer can choose whether or not to receive advertisements related to an item in the list. Via the shopping list, a buyer can also change the status of a “Wanna Ads” feature (which stands for Want to receive Advertisement or not) in the shopping list.

As an example, if a user selects the item “rice”, then the universal network market system may properly associate “rice” with a “food category” in the shopping organizer. The default in this case can be “food category”. The universal network market system allows the user to associate another category with the item “rice”. For example, the user may use the category “edible.” The user may be allowed to define his own category for “rice”, according to certain embodiments. Rice can be assigned several different categories, simultaneously. The use of categories allows the universal network market system to manage data more efficiently. Also, the use of categories allows the universal network market system to determine the relationship between items for finding promotions, related items and related promotions.

The universal network market system may initially present a template shopping list to a buyer. In one embodiment, buyers and/or sellers can provide suggested templates that may be used as the template shopping list. The universal network market system may permit a buyer to customize the template shopping list to suit the buyer's own individual needs and desires. Buyers may also be permitted to maintain multiple shopping lists based on their needs and desires. Some sample shopping lists are shown in FIG. 5 and include a “My Immediate” shopping list 502, a “My Regular” shopping list 504, a “My Interested” shopping list 506, a “My Reminding” shopping list 508 and a “My Prediction” shopping list 510. The generated shopping list can use a shopping expert of the universal network market system to prepare information regarding the related price, item carrier, and product/service information for each item in the shopping list.

In one embodiment, default product expert criteria (e.g., a shopping expert) may be prepared for each item in the “My Immediate” shopping list 502 and the “My Regular” shopping list 504. With such a shopping list scheme, a buyer can go shopping using, for example, the buyer's “My Immediate” shopping list 502. Via the buyer's client device (e.g., a hand held computing device), the buyer may obtain access to the shopping expert and shopping list features of the universal network market system anywhere the buyer's device is in communication with the universal network market system.

In one embodiment a general list may be prepared for a client buyer. A general list may comprise a category of all possible products and service that are known to the universal network market system. One purpose of the general list is to help a buyer build up the buyer's own “My Immediate” shopping list 502, “My Regular” shopping list 504 and/or “My Reminding” shopping list 508. The buyer can review items presented (e.g., listed) in the general list, and then move whatever item to the buyer's “My Immediate” shopping list 502 and/or “My Regular” shopping list 504. The “My Interested” and “My Prediction” shopping lists 506, 510 may be used by the universal network market system to attempt to predict what the buyer may need based on a shopping profile of the buyer maintained by the universal network market system. Additional shopping list can be built according to a given buyer's needs or desires.

Any particular item can belong to one or more categories of shopping lists. For example, a staple product such as rice or milk can belong to the “My Immediate” and “My Regular” shopping lists 502, 504 at the same time while a digital camera, on the other hand, may be included only in the “My Interested” shopping list 506 since it may be considered more of a specialty item.

The sample categorized shopping list (e.g., the shopping organizer) 500 shown in FIG. 5 may be presented to a user via a visual display of the client device used by the buyer. The shopping lists 502, 504, 506, 508, 510 included in the categorized shopping list 500 may each contain a user-selectable link to permit the user to access and display a given shopping list upon selection of the associated link.

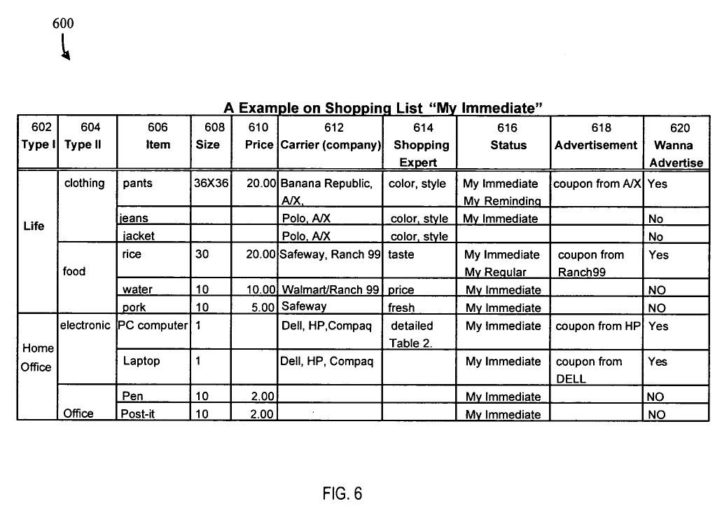

FIG. 6 is an illustrative “My Immediate” shopping list 600 of a representative buyer in accordance with certain embodiments. Such a list 600 may be presented to a buyer upon selection of the associated link of the “My Immediate” shopping list 502 shown in FIG. 5. The “My Immediate” shopping list 600 shown in FIG. 6 presents a list of all of the items that a buyer may want to purchase or obtain immediately or at least in the near future. Thus, a buyer can go shopping using the “My Immediate” shopping list 600 in order to help remind the buyer of the items that are most desirable to the buyer and thereby facilitate/make more convenient a buyer's shopping experience.

The universal network market system may initially provide a buyer/user with a template for any given shopping list so that the buyer can immediately begin using the list and input items into the list. The universal network market system may also permit a user to customize and alter these templates to suit the needs of a given buyer/user. As shown in FIG. 6, a sample version of a template for the “My Immediate” shopping list 600 may include the following columns for presenting corresponding information about items on the list: Type I 602, Type II 604, Item 606, Size 608, Price 610, Carrier 612, Shopping Expert 614, Status 616, Advertisement 618, and Wanna Advertise 620. As previously mentioned, the universal network market system may permit a buyer to customize the buyer's “My Immediate” shopping list 600. In addition, a buyer may be permitted to add and/or remove items from the “My Immediate” shopping list 600.

The Type I and Type II columns 602, 604 allow categorization of items in the lists. Some sample Type I categories include Life and Home Office. Type II categories may comprise subcategories to an associated Type I category. Some sample Type II categories include clothing, food, electronics and office supplies.

The columns for size, price, carrier and shopping expert (columns 608, 610, 612, 614) include parameters that help buyers decide on products listed in column 606.

The Status column 616 identifies the shopping lists that is associated with item (e.g., the item can be included in My Immediate, My Regular, My Interest, My Reminding, My Predicting lists (see FIG. 5)). Since an item can belong to one or more of these lists, the status column can include multiple lists in the entry of any give item.

The Wanna Advertise column 620 is a column in which a buyer/user can specify whether to allow the universal network market system to find and send the buyer advertisements that are associated with an item of interest. As shown in FIG. 6, the Wanna Advertise field may have two choices: “Yes”—indicating that the buyer is willing to receive advertisements and “No”—indicating that the buyer is not interested in receiving advertisements.

The entries for the Advertisement column 618 are where coupons that have been found for the associated item can be stored and identified (if the user selects “Yes” in the Wanna Advertise column 620 for the item). We will update buyer for timing critical Ads. Additional columns can be added to the sample template of FIG. 6 to extend the services provided by the universal network market system.

The universal network system can also organize and present the “My Immediate” shopping list in a different format. For example, all of the items in the “My Immediate” shopping list can be organized according to shop/store (e.g., items that are available at Macy's can all be grouped together in one group while items that are available at Costco are grouped together in another group). Thus, a buyer may be able to optimize his “shopping path,” so as to shop in a more focused and efficient fashion.

### “My Regular” Shopping List

The “My Regular” shopping list may be used to keep track a user's (e.g., a buyer) regular shopping behavior. For example, a person may need to regularly buy food, water, clothing, toiletries (e.g., toothpaste, toothbrush, toilette paper) as well as pay bills for utilities and other services. Such times can be grouped together in the user's “My Regular” shopping list.

The user's shopping behavior can then be set up to track a user's shopping habit related to any item that is listed in the user's “My Regular” shopping list. For example, if a user needs to buy one bag of rice, three tubes of toothpaste, five packs of napkins every three months (at, for instance, a given store such a Costco warehouse store for example), these items may be stored and organized in the My Regular shopping list for the user.

### “My Reminding” Shopping List

Once a general shopping list for a user is established along with a “My Immediate” and “My Regular” shopping lists for the user, the universal network market system can use this information to help identify/ascertain a user's shopping behavior and shopping habits by knowing what product/service a user needs to buy regularly (from these lists). In use, the universal network market system may check the user's “My Regular” shopping list frequently (e.g., periodically). Once the universal network market system identifies through its analysis that some items in the “My Regular” shopping list need to be purchased again by the user, the universal network market system can place those items in the a “My Reminding” or “My Reminder” shopping list. The universal network market system can also send a notification to the user to remind the user that some items (e.g., the items in the “My Reminding” list) in their list may need to be replenished in the near future. Once the user receives the notification, the user can then check the My Reminding shopping list to identify which items need replenishment. The user can then move those necessary items to the user's “My Immediate” shopping list for immediate shopping.

Continuing with the earlier example, if the universal network market system knows that a user needs to buy one bag of rice, three tubes of toothpaste and five packs of napkins every three months at given store (e.g., Costco), then the universal network market system can place entries for the rice, toothpaste and napkins in the user's “My Reminding” shopping list every three months and remind the user when it is time to buy rice, toothpaste and napkins at Costco.

In one embodiment, the “My Reminder” shopping list may be used by users to intentionally keep items of which they want to be reminded. For example, a user may want to be reminded annually of a birthday (or birthday gift), anniversary, holiday, or the filing of a patent before a statutory or other deadline.

### “My Interested” Shopping List

A user may selectively designate items for inclusion in the user's “My Interested” shopping list. In general, a user may place any items of interest in “My Interested” shopping list. When placing an item in the “My Interested” shopping list, user may also select whether to receive advertisements for the item (e.g., through the use of the “Wanna Advertise” field)

### “My Prediction” Shopping List

The “My Prediction” or “Predicting” shopping list is where the universal network market system can put items that the universal network market system predicts the user may need based on the user's shopping profile (e.g., shopping behavior captured from, for example, the user's various shopping lists). Cross-selling and up-selling of items can be achieved via the “My Prediction” list by having the universal network market system try to predict and present products/services and related product/service information that the user may be interested to the user.

In an implementation where buyer/users may be worried about privacy, the universal network market system may permit a user to set up an account with the universal network market system without the buyer having to include his or her personal information. In such a fashion, shopping lists in such an implementation can help improve a buyer's shopping experience without sacrificing the buyer's private information. Similar privacy can be afforded to sellers (e.g., commercial companies trying to sell a product or service) as well. For example, sellers can provide the universal network market system with items and services that they want to sell via the universal network market system. The universal network market system can then place the seller's information (e.g., information about a product, the product's release date and the product's applications as well as coupons for the product and other product/service information in the universal network market system).

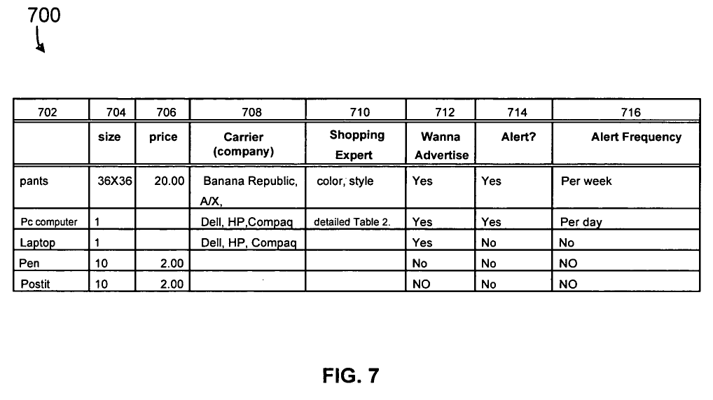

FIG. 7 is an illustrative buyer's service request list 700 in accordance with certain embodiments. As shown in FIG. 7, the buyer's service request list 700 may include entries (e.g., rows) for items (as set forth in the items column 702) and may include columns for size 704, price 706, carrier 708, shopping expert 710 as well as “Wanna Advertise”, Alerts and Alert Frequency columns 712, 714, 716 for each item. The size, price, carrier, shopping expert and “Wanna Advertise” columns 704, 706, 708, 710, 712 are as previously described. Via the Alert and Alert Frequency columns, a user can specify whether to receive alerts for an item and the frequency for receiving such alerts. If the buyer selects to receive alerts (e.g., a “Yes” for the item in the Alert column 714), the universal network market system can then provide alerts to the buyer about coupons, as well as product release information, that may be available for the item. Such alerts can be transmitted to the buyer via, for example, telephone calls, text messaging, email and so on. Thus, a buyer can be notified about coupons and other product information quickly. The Alert Frequency column provides a buyer with an option to specify how often the buyer will be sent alerts (e.g., how often the buyer will be alerted).

With a buyer's service request list 700, a buyer can specify different services for different items. The service request list 700 can be extended to add or extend services as necessary.

In one implementation, the universal network market system may, for some timing critical advertisements, send alerts to buyers even when a buyer has chosen not to receive alerts (e.g., selected the “No” option in the Alerts column 714). For example, if the universal network market system finds an online coupon for a laptop for the discounted price of US $100 that is valid for only three hours, the universal network market system may update a buyer on this advertisement because its timing is critical.

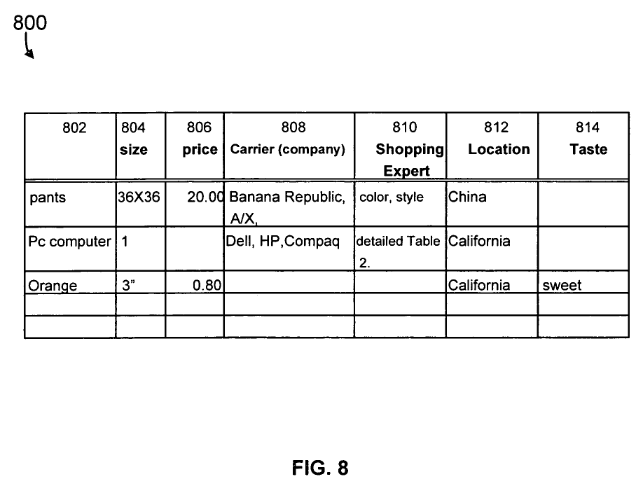

FIG. 8 is an illustrative item requirement list 800 in accordance with certain embodiments. Like the buyer's service request, the item requirement list 800 may include columns for each item (listed in the item column 802) so that a buyer user can specify size 804, price 806, carrier 808, shopping expert 810 as well as location 812 and taste 814 for the items in the list. The location and taste columns 812, 814 allow a buyer to selectively define location and taste requirements for any item in the item requirement list. For example, in the location column 812, the buyer can specify whether to receive alerts and other information for pants from China and oranges from California. In the taste column 814, the user may be able to specify sweet oranges rather than tart ones, for example.

### Shopping Expert

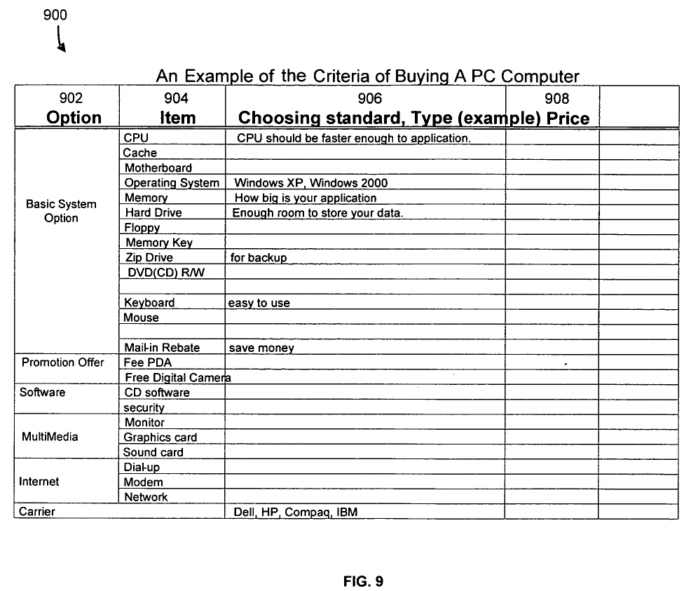

FIG. 9 presents an illustrative shopping expert 900 (which may also be referred to as “expert's criteria”) that may be presented to a user by a universal network market system in accordance with certain embodiments. The universal network market system may utilize a shopping expert 900 to help educate a buyer on how to select a given item or service. In the illustrative shopping expert 900, for example, information is presented to a user by the universal network market system on how to choose a personal computer (PC). As shown, the universal network market system may generate a shopping expert for a PC that presents various information about PCs in a variety of rows and columns such as, for example, an option column 902, an item column 904, a “choosing standard” column 906 and a price column 908. The presented shopping expert 900 may also separate PC options into different rows (or sets of rows) such as, for example, a basic system options, promotion offers, software, multi-media, Internet and carrier. Other columns may be added to present further information to a user.

The information presented by the universal network market system in a shopping expert 900 is intended to provide the buyer with criteria for evaluating a product or service. The universal network market system may also use the shopping expert 900 to list products and/or services that meet various criteria established by the buyer (via, e.g., information provided in the buyer's request list), and to identify locations (e.g., shops/websites) where the products and/or services are available. Some additional sample criteria can include, budget, performance parameters, closest store and/or service provider. As an example, a buyer can specify a price range, and performance parameters, and the Shopping Expert will show the buyer the most recommended products in the specified price range and that meet the specified performance parameters.

By using a shopping expert, buyers can tell the universal network market system what they are interested in buying or what services they are interested receiving. The shopping expert can then be used by the universal network market system as a vehicle to present detailed information/criteria on how to choose a product or service to the buyer. The shopping expert component of the universal network market system may be interactive. For example, the shopping expert can be used to teach the buyer how to evaluate and choose a product or service. Once the buyer becomes familiar with the presented criteria, the shopping expert may be used to conduct an online-interview with the buyer and ask the buyer questions related to the product or service. The shopping expert can then be used to suggest a list of available products or services based on the buyer's answers to the questions.

A shopping expert component of the universal network market system may categorize all the information on the commercial products/services stored in the universal network market system, such as electronics, hardware, kitchen and books, or services. The shopping expert component of the universal network market system can then build a product expert criteria form or page for each product/service. At the same time, the product and service database used by the shopping expert component can be continuously updated with, for example, the latest information on the best coupons for given products/services, the most attractive advertisements, the newest product releases and any other product/service related information. Thus, the shopping expert component can response to buyers' requests quickly and precisely.

### Customer-Oriented Advertisements (One-To-One Marketing)

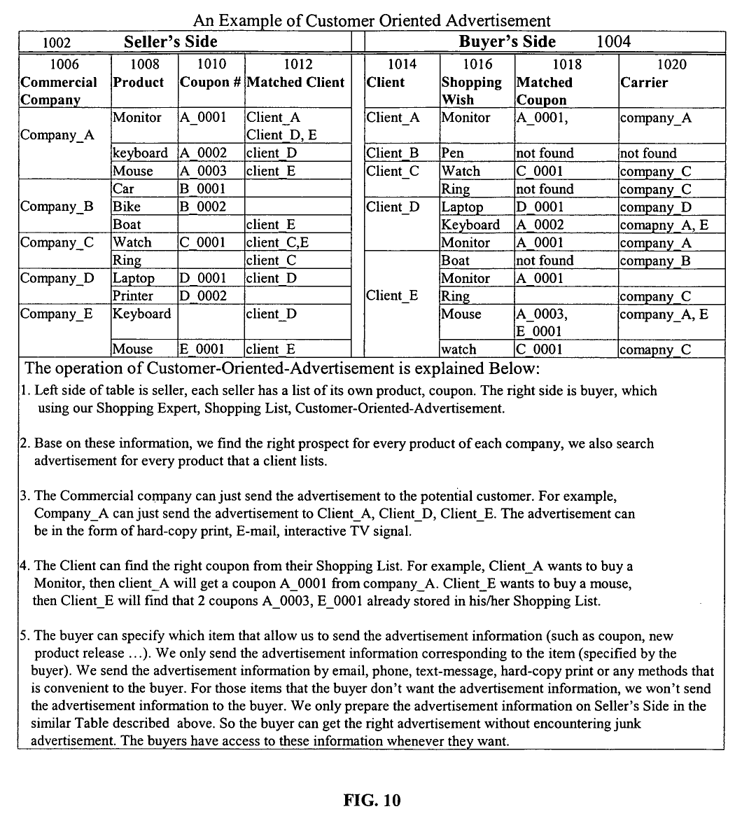

FIG. 10 shows illustrative tables that may be used to provide customer-oriented advertisements in accordance with certain embodiments. The universal network market system may use such tables to search for advertisements to present to various buyers. By using such a system, presenting advertisements changes from a passive approach to an active approach where buyers identify to the universal network market system the items and services of interest. Thus, the universal network market system can select advertisements for sending to the buyer based on the identified items and services of interest.

Based on buyers' shopping lists, the universal network market system can determine what buyers need and what buyers will be most receptive to receiving offers from sellers. Thus, the universal network market system can send the right advertisement to the buyer by electronic mail, interactive TV signal or hard-copy print or by other communication channels. Via the universal network market system, buyers can receive the latest advertisement, coupon, bonus point, and product releases of interest. As a result of such targeted advertising, a buyer may be more likely to read and give more attention to advertisements.

To provide customer-oriented-advertisements, the universal network market system utilizes two tables: a seller table 1002 and buyer table 1004. The seller table 1002 includes entries for a plurality of sellers with the name of each seller identified in a commercial company column 1006. The seller table 1002 also includes product, coupon number and match client columns 1008, 1010, 1012 in which products of a given seller can be identified along with specific coupons that are associated with the given product and the identities of buyers (e.g., clients) that have been determined to be “matches” for the product (e.g., buyers that are most likely to be interested in receiving promotional information about the given product). The buyer table 1004 includes entries for a plurality of buyers (e.g., clients) with the name of each buyer identified in a client or buyer column 1014. The buyer table 1004 may also include columns 1016, 1018, 1020 for desired products (e.g., shopping wishes), coupons that match desired products, and sellers associated with the matched coupons. The buyer table 1004 may also include columns 1008, 1010, 1012 for product, coupon number, and matched client, in which products of a given seller can be identified along with specific coupons that are associated with the given product and the identities of buyers (e.g., clients) that have been determined to be “matches” to the product (e.g., buyers that are most likely to be interested in receiving promotional information about the given product).

Some or all of the columns of the buyer table 1004 can be populated with information obtained form the shopping expert and the buyer shopping lists. Based on this information, the universal network market system can find the right prospect for a given product of a given company. The universal network market system also can search for advertisements for a given product that is included in the buyer table 1004. Using such tables, a seller (e.g., a commercial company) can send a targeted advertisement to a potential customer. For example, using the tables 1002, 1004 shown in FIG. 10, Company_A can send an advertisement for a monitor to Client_A, Client_D, Client_E. The advertisement can be in the form of hard-copy print, E-mail, interactive TV signal, etc.

The advertisement may also include or be linked a coupon having the code A_{—}0001 so that it can be more easily identified and tracked. Using the tables shown in FIG. 10, the appropriate coupons may be found and provided to a buyer via his or her shopping list. For example, Client_A wants to buy a monitor. Client_A may receive a coupon A_{—}0001 from Company_A. Client_E wants to buy a mouse and, as a result, the universal network market system may include coupons A_{—}0003, E_{—}0001 in the shopping list of Client_E.

Using tables 1002, 1004, universal network market system may allow a buyer to specify items of interest and then send the advertisement information (such as coupon, new product release information) associated with the specified items of interest. The advertisement information may be sent by email, phone, text-message, hard-copy print or any method that is convenient to the client. For those items for which the buyer does not wish the advertisement information, the universal network market system does not have to send any advertisements information.

Using the shopping list, the universal network market system knows what product/service a buyer wants. A buyer can specify which item that they are willing to allow the universal network market system to send them advertisement and other information on (such as, for example, new products, product updates, events, promotions, special offers). The universal network market system can provide the advertisement information corresponding to the item as specified by the buyer. For those items that the buyer does not want to receive advertisement information, the universal network market system will not send such advertisements to the buyer.

From the tables 1002, 1004 of FIG. 10, for example, the universal network market system can gather sufficient information on buyers and sellers so that effective management of buyer/seller information can be achieved—the universal network market system knows what buyers want to buy and what sellers can sell. Through such a table, a one-to-one market can be achieved.

Since the universal network market system has customer contact information, the universal network market system can help merchants (sellers) identify prospective buyers/customers. The universal network market system can be used to identify which customers are the most profitable for a given company. The universal network market system can also create a buyer's shopping profile. The shopping profile can be used to predict the likely behavior of each buyer for use in a given company's marketing efforts. The merchants or advertisers can access to the user's shopping profile through a mapped user ID so as not to compromise the buyer's privacy. The universal network market system can also make information on the buyer's needs available to advertisers. The advertisers can analyze such information for determining the most popular products and services, and for determining the buyers or group of buyers that are most likely to buy the advertisers' products and services.

Using the Customer-Oriented Advertisement approach facilitated by the universal network market system, sellers can achieve better advertising effects with less costs and effort. Cross-selling and up-selling can also be enhanced. Buyer's privacy does not have to be sacrificed since the universal network market system can be implemented to provide only user-IDs to buyers. In addition, contact between buyers and sellers may need to go through a communication channel of the universal network market system so that no advertisement can reach the client without permission from the client. In one implementation, direct contact between the seller and the buyer may be permitted if requested by a given buyer.

By using the Customer-Oriented Advertisement features of the universal network market system, commercial companies can identify the potential prospect/customer and send the advertisements to such customers. The universal network market system can create a shopping profile and predict likely shopping behavior for a given client. Such features can be valuable to a company's marketing efforts.

Embodiments of the universal network market system can be implemented to minimize the interference with a user's shopping experience. In addition, the universal network market system can be used to achieve effective management of company (merchant)/customer information. By knowing what a buyer wants to buy, and what a seller can sell, the universal network market system can predict what type of product/service that is of interest to a buyer.

In one embodiment, the universal network market system may reserve a portion of its user interface to present products/service that a buyer may be interested in (e.g., a cross selling opportunity). While a buyer is interacting with the universal network market system, the universal network market system may present information/advertisements about products/services intended to catch the intention of the buyer. For example, if a buyer is looking for a coupon for a Dell laptop, the universal network market system can predict that the buyer may also be interested in a Dell printer. As a result, the universal network market system can present the latest advertisements, coupons, bonus points, product release information on various Dell printers to the buyer. The presentation of this information can be done in the reserved area of the interface so that the information will not interfere with the buyer's present shopping experience.

As an other feature, the universal network market system can prepare present a list of categorized items and their related information (using shopping expert, shopping list, customer-oriented advertisement components of the universal network market system) to the buyer. For example, when a buyer is using the universal network market system to obtain information about a ballet performance (e.g., the location of the performance and/or any specials for the ballet performance), the universal network market system can deduce that the buyer is interested in the performance. The universal network market system can then present the buyer with categorized information on this performance such as, for example, Type of Performance, Actors, Location, and Parking information.

The universal network market system may also be implemented to respect a user's privacy by requiring all communications between a buyer and a sell to go through the universal network market system unless the buyer requests direct communication with a seller and obtains the permission of the universal network market system to do so. Additional privacy is afforded because the buyer can choose what type of advertisements, products, companies, and brands that the buyer is interested in and block all other advertisements (e.g., via a buyer's request). Ads can be served or sent to a buyer through the universal network market system. In one embodiment, with the buyer's permission, the ads can be served/sent to buyer through any third-party, including the seller.

In sum, the Shopping Expert, shopping list, Customer-Oriented Advertisement may include information both from commercial companies and from all kinds of potential customers. By this way, a Virtual Link can be built through the universal network market system between commercial companies and their potential customers. This link allows a company (even small company) to build its own virtual sales force for any product, for even low-priced or low margin goods and services.

The Ads selection can be done at the background since the universal network market system may use buyer's stored information. The system may select Ads, promotions, production information for buyer while the buyer is using the network device or not using the network device. Then the system may send/present/serve the selected information to buyer, or keep the selected the information in the buyer's account. In one embodiment, such a process may be used to differentiate one of more aspects of the universal network market system from traditional search engines in that usually do their searching (or selecting) while a user is actively online.

### Finding Timing-Critical Advertisements and Information

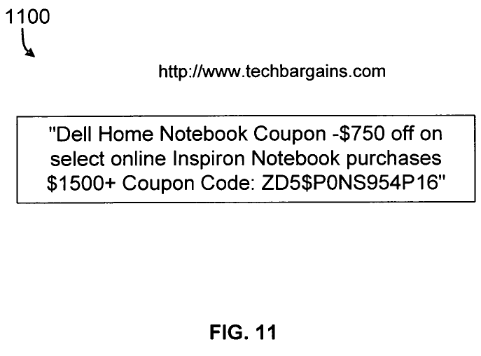

FIG. 11 is a sample timing-critical advertisement 1100 that may be presented to a buyer in accordance with one embodiment. Timing-critical advertisements may be provided by the universal network market system to present users with information/offers that they may not be aware of and that may last for a short duration. As an example, suppose there are several buyers using the universal network market system that indicate that there are interested in purchasing a discounted DELL laptop. If the universal network market system becomes aware of a short term promotion: “Dell Home Notebook Coupon −$750 off on select online Inspiron Notebook purchases $1500+ Coupon Code: ZD5$P0NS954P16” at “www.techbargains.com” on a given date. Most of traditional buyers would miss this advertisement because they either didn't know the web site “www.techbargains.com” or they didn't read the web site on that particular time when the promotion was being presented. In contrast, the universal network market system scans the websites of known sellers for promotions. These sellers may be identified, for example, as those listed in buyers' shopping lists maintained by the universal network market system. If a short term promotion is encountered, the universal network market system notifies buyers that have indicated in their shopping lists that they are interested in purchasing a Dell computer. This information can be relayed to the appropriate buyer via email, cell-phone, or a hand-held device, etc.

The search for timing critical advertisements by the universal network market system may be conducted by searching sites of companies identified in the shopping lists of the buyer-users of the universal network market system as well as the sites of seller-users of the universal network market system. When an advertisement is found, the universal network market system can match the advertisement to buyers and sellers based on the buyer and seller profiles. In one implementation, the timing-critical advertising component of the universal network market system may include a search engine for advertisements. The universal network market system may search for items (products, product release, product information, promotions) available from sources other than from sellers having a seller's account with the universal network system. In one aspect, portions or all of this kind of search may be performed by a computer or by a human being.

Once the universal network market system has found a timing-critical advertising, the universal network market system will alert buyers it has matched to the advertisement to inform these buyers of the special offer.

### Direct Selling with Minimum Product Inventory

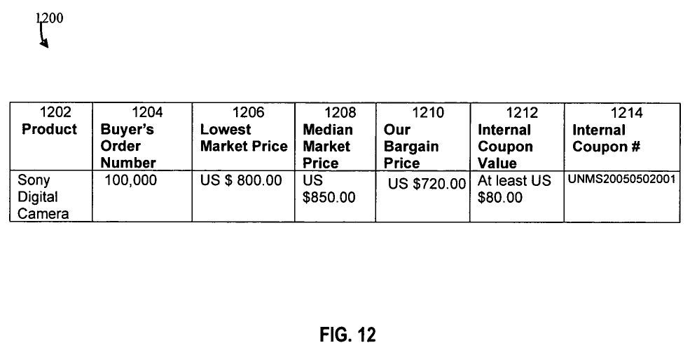

FIG. 12 is an illustration of a table 1200 that may be used by a universal network market system to conduct a direct selling event in accordance with certain embodiments. When the universal network market system has several (e.g., one or more) buyers including the same product or service in their shopping list, the universal network market system may undertake an effort to buy the product/service directly from its seller/manufacturer/provider at a lower price than would be available through traditional retail channels. This may be possible because the number of orders for the given item could be significant. The universal network market system may collect information from its buyer-user's shopping lists to ascertain a common or maximum purchase price at which the buyers would consider purchasing the product. In the example shown in FIG. 12, the product 1202 could be a digital cameral from Sony Corp. The table may include columns (e.g., fields) for the number of interested buyers 1204, the lowest market price 1206 (e.g., retail price) for the product, the median retail price 1208 for the product, a bargain price 1210 offered by the universal network market system, a value 1212 of an internal coupon and identification number 1214 of the internal coupon. In the example shown in FIG. 12, because of the large number of interested buyers, the universal network market system could hypothetically negotiate a bargain price that is $80 lower than the lowest retail price. One way that the bargain price can be offered to buyer-users of the universal network market system is to generate and send a coupon (with its coupon identification number) for the $80 discount to the buyers. The coupon identifier may be assigned to the coupon by the universal network market system when the coupon is generated by the universal network market system. One advantage of this bargain feature is that the universal network market system can determine the number of highly likely sales from the shopping lists of its buyers by identifying those buyers that include a camera in their “My Immediate” shopping list for example. This also helps to keep inventory of the product at the universal network market system down to a low minimum so that large warehousing costs are not incurred by the universal network market system (and such savings can be passed on in the lower bargain price).

In one embodiment, the universal network market system may provide the likely sales information to a seller/manufacturer/provider so that they can better control their inventory and production line.

### Generating a Brochure of Customer-Specific Advertisements Soft-Copy or Hard-Copy

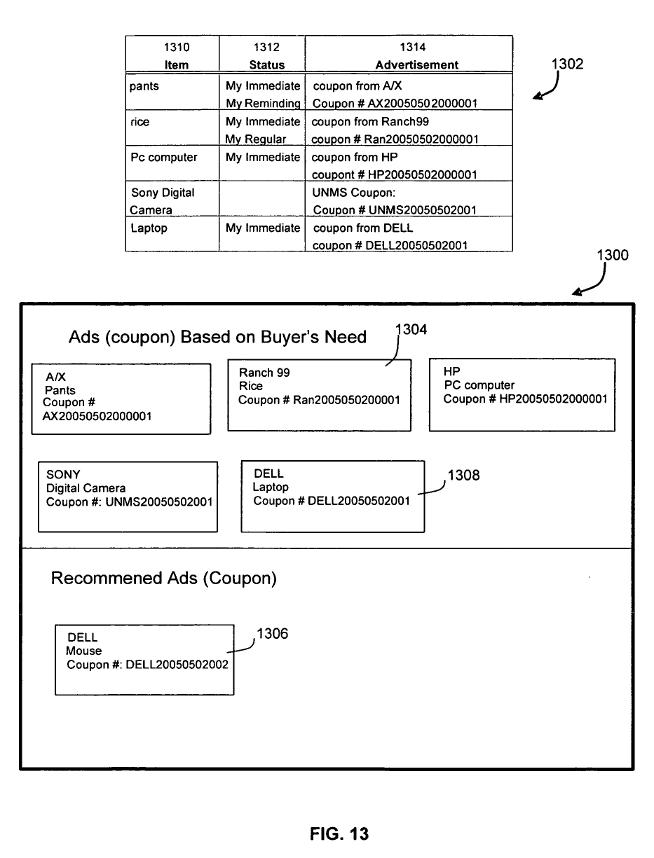

FIG. 13 is an illustrative Customer-Specific Advertisement Magazine 1300 that may be generated by certain embodiments of universal network market system using information 1302 collected from buyers' shopping lists. The generated Customer-Specific Advertisement Magazine 1300 may include a plurality of customer specific advertisements presented as images, tables, figures or other forms.

Based on buyers' shopping lists and buyer and seller tables, the universal network market can search for advertisements of sellers that may be of interest to a given buyer. These advertisements may then be used to generate the customer-specific advertisement magazine for the buyer that includes advertisements 1304 that the buyer may be interested in based on the information obtained from the buyer's shopping list. The customer-specific advertisement magazine may also include advertisements 1306 (e.g., recommendations or recommended advertisements) for products that may be related to the buyer's needed items (e.g., cross-selling advertisements). The generated magazine can then be sent to the buyer over the Internet by email for example or in a hard copy via regular postal service mail. The advertisements can include an coupon identification number 1308 so that a buyer can then make a purchase of the item that takes advantage of the coupon. In an online version, the advertisements may comprise links to the particular page of a seller's website at which the identified product/service is being offered for sale.

As shown in the table 1302, the advertisement column 1314 identifies coupons that are associated with a given item (see the item column 1310) while the status column 1312 may be used to identify the urgency of the need of the buyer for the product. The coupon identifier may be stored in the Advertisement column 1314 with its associated coupon.

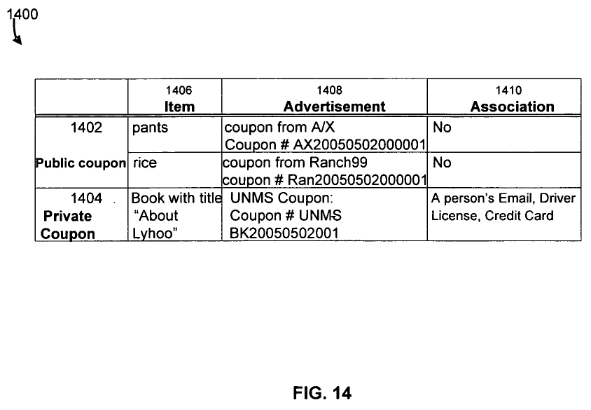

FIG. 14 is an example of a table 1400 that may be used to generate ID-related coupons in accordance with an illustrative embodiment. The Customer-Specific Ads features of allows the distinguishing between public coupons 1402 and private coupons 1404. A public coupon may be defined as coupons that are made available to everyone while a private coupon may be defined as an identifier (ID)-related coupon that can be generated for a particular person(s). Private coupons may be used as a tool to attract users to the universal network market system. An ID-Coupon may be associated an identifier of a given user such as a credit card number, driver license number, e-mail address, cellular phone number of the user. For example, a private coupon of “About Lyhoo” may be given to only employees of the company Lyhoo, Inc. Such a coupon can be associated with the identification of all employees of Lyhoo, Inc. This way the convenience of an electronic coupon may be facilitated while permitting an advertiser to control who is to receive and use the coupon. In the present example, employees of Lyhoo, Inc. can simply present an appropriate ID (credit car, driver licenses, email address, cellular text message) to show that they are entitled to the coupon.

As shown in FIG. 14, the table 1400 may include an item column 1406 for identifying items associated with a given advertisement, an advertisement column 1408 for describing the advertisement associated with the item (including its coupon identification number). An associate column 1410 may be used to indicate whether a coupon is public or private by indicating whether or not a certain type of ID is needed to redeem the coupon. For example, the public coupons may have a “No” entry in the association column 1410 to indicate that no special ID is needed to redeem the coupon while the entry in the associate column 1410 for a private coupon may indicate the specific ID (or types of ID) that are needed in order to redeem the coupon.

### An Efficient Advertisement Referral System

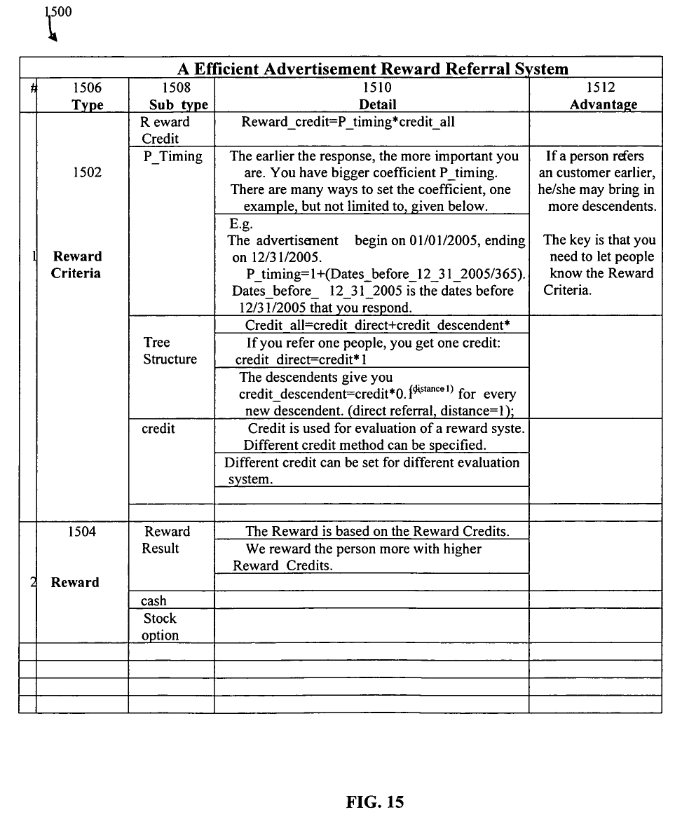

FIG. 15 is a table 1500 that may be used to afford an efficient advertisement reward referral system in accordance with certain embodiments. As shown in FIG. 15, the table 1500 includes rows for different types of reward criteria 1502 and rewards 1504. The table 1500 may also include columns that indicate the type 1506 and sub-types 1508 of reward criteria and rewards. For each sub-type, the table may also include a detail column 1510 for providing details about the specific reward criteria or reward subtype. An advantage column 1512 may also be included for providing details about various reward criteria or rewards. As shown in FIG. 15, reward criteria sub-types can include, reward credits, P_Timing, Tree Structure, and credit while rewards sub-types can include reward results, cash, and stock options.

The details column 1510 may set forth various algorithms used to define the associated sub-type. For example, the reward credit sub-type may be defined as the product of the P_Timing sub-type and the credit_all sub-type. As shown in FIG. 15, P_Timing may be defined by the earliness of the response: the earlier the response, the more important the user is and thus the user receives a higher coefficient P_Timing. P_timing is a scaling factor. In such a manner, early responses by buyers to advertisements can be rewarded more generously than later responses. The credit sub-type can come from both from direct references and indirect references from a direct reference where the measure of the reference is defined by distance. In one embodiment, the less distance the referral is away from the user, the more credit the user will get (e.g., the more direct the referrer, the more credit given).

### Distance

Distance may be further defined as how many “degrees of separation” a given user is from another user. Values may include, for example: one degree away—e.g., directly connected to the given user which means that the user is referred directly by the given user; and two, three or four degrees away: e.g., a friend of a friend is two degrees of distance, one of their friends is three degrees, and one of theirs is four degrees. In one implementation, a user can get credits through all these referred-back distance. If there is more than four degrees of separation, less credit may be awarded for a user referral.

### Linked Rating System

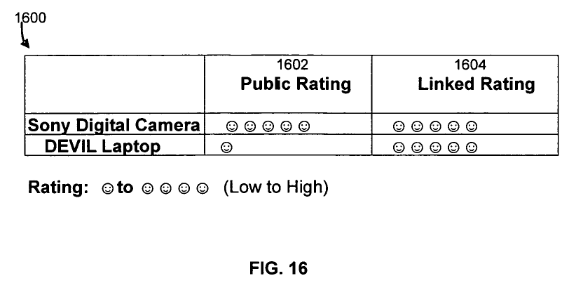

FIG. 16 is an example of an illustrative Linked Raking System 1600 in accordance with certain embodiments. A linked rating may be defined as a rating that is given by the people a user knows and/or trusts. A regular rating system typically rates a product/service based on the number of votes (e.g. pro or con votes) it receives. All votes are equal and the voters don't really know one another. In most cases, people tend to trust their friends or a similar group of people that may have similar ideas and tastes. As a result, such people may tend to give a similar rating to a particular item or service. Linked ratings are those ratings made by users that are linked as previously described (see Distance). As shown in FIG. 16, both public and linked ratings 1602, 1604 of a given product may be presented side by side by the universal network market system so that users can compare the various ratings on a product. In the example shown in FIG. 16, the public and private ratings for a Sony-brand digital camera are both high (e.g., the more faces, the higher the rating) while the Devil-brand laptop has a low public rating but a high linked rating. This indicates that the users that are linked to the given user viewing the rating comparison have given a higher rating to this laptop than the general public. This may be due to, for example, a common preference or need of the linked users that is unique to the linked users and not really found that prevalently in the general public. With such a linked rating, a user may decide to go against public opinion (as represented by the public rating) and purchase a Devil-brand laptop because other users that are linked to this user gave it a high rating.

### A Collection of Menu, Installation Software and Other Product/Service Information

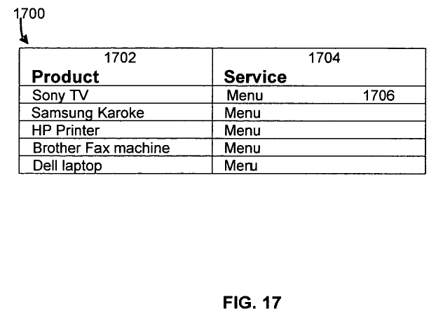

FIG. 17 is an example of a Menu/Installation Software table 1700 that may be afforded by a universal network market system in accordance with one embodiment. In today's society, many products and services come with complicated product menus, installation software and other product/service information. Many people who buy these kinds products do not keep these documents, menus, installation software in an organized manner and, as a result, they cannot find these items when they subsequently need them. As an example, suppose a user purchases a Sony-brand TV, a Samsung-brand Karoke system, an HP-brand printer, a Brother-brand fax machine, and a Dell-brand laptop. One day, the user may discover something wrong with his laptop and needs to use the system installation/recovery disk software to fix it but, of course, the user cannot locate the disk. An embodiment of the universal network market system may use a version of the shopping list to store such kinds of product related information. The universal network market system may collect or at least gather links to the various support documents of a given provider or product 1702 and present the support information 1704 in the table 1700 with user-selectable links 1706 to permit a user to access the support documents, the product/service Menu, Installation software and any other product/service information. The support documents may be categorized by the universal network market system according to, for example, company, product type, and service type. Using such a table may make it easier for a user to access such documents.

### Tools and New Service

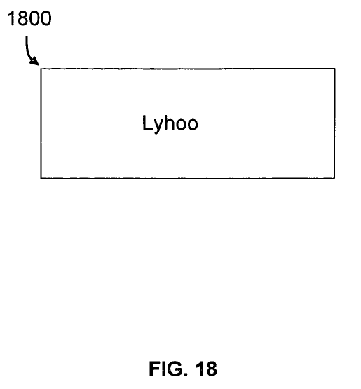

FIG. 18 is a sample browser/toolbar 1800 for a universal network market system in accordance with one embodiment. The universal network market system may include interfaces for buyers and sellers. The universal network market system may include software for our buyers and sellers to download to their own computer. Special interfaces may be created for interactive television, interactive voice response, handheld device or any other device. The toolbar 1800 may be created to help provide easy input by a user. When a user views a product, the toolbar may permit a user to decide whether to put a suggested item in the user's shopping list.

As for hardware, a buyer or seller user may use computers, handheld device, phone camera, TV, interactive voice response, call centers, store fronts, ATM, kiosks, digital camera or any other device that can get access to the service provided by the universal network market system. The universal network market system may use digital cameras or other readers to read a bar codes and then automatically connect a user to the universal network market system. Embodiments may also include RFID readers to read RFIDs to connect to the universal network market system.

Currently, advertisements on television is generally broadcast to its entire viewing audience. However, with the development of interactive television and radio, customer-specified-advertisements may be sent to a user using the universal network market system via these interactive channels. For example, a buyer may tell a television that he or she is interested in a BMW car. Then, the television can will select Ads (e.g., promotions, product information, coupon) related to BMW cars and present the selected Ads and other proper Ads to the buyer. A buyer may also choose to view general Ads programs at the same time. In this case, the television may always present Ads to the television viewer. The television viewer may have to view some Ads whether the television viewer chooses Advertising alerts or not. In one embodiment, television viewers may be able to only choose Ads that he/she may like a little more.

Embodiments of the service provided by the universal network market system may be implemented so that they are buyer focused. In such implementations, a buyer can tell the system what they want to buy, and the universal network market system will do the rest for the buyer. Although, the universal network market system may include the step of matching buyer and seller needs once the universal network market system have both side's information.

A buyer or seller may organize/store their information locally at their own computer or other device such as television. The universal network system and its related database can be implemented/stored/executed centrally, distributively, locally, or in any above combination. The client (buyer or seller) may need to update our central universal network system database.

### Sample Processes and Environments

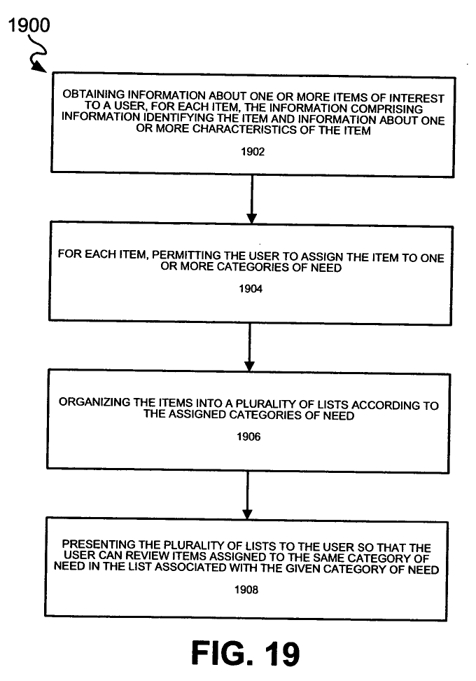

FIG. 19 is a flowchart of a process 1900 for organizing items of interest for presentment to a user in accordance with certain embodiments. In operation 1902, information may be obtained about one or more items of interest to a user (e.g., a buyer). For each item of interest to the user, the obtained information may include information identifying the item (“item identity information,” e.g., what the item is, e.g., rice) and information about one or more characteristics of the item such as, for example, size and/or quantity of the item, a price for the item (e.g., a retail price and/or a price at which the buyer would be interested in purchasing the item), a seller, manufacture, designer and/or provider of the item (e.g., Safeway or Armani). In operation 1904, the user, for each item of interest, may be permitted to assign the item to one or more relative categories of need based on, for example, the relative need by the user for the item. In operation 1906, the items may be organized into a plurality of item lists according to the item's assigned categories of need. In operation 1908, the plurality of lists may be presented to the user in a user-selectable format so that the user can select and review items assigned to the same category of need in the list associated with the given category of need.

A network (such as, e.g., the Internet) may be utilized to obtain the information from the user and present the lists to the user. The information may be obtained from the user by presenting, to the user, an interface capable of receiving input about the items from the user. The interface may present graphical images of a plurality of items from which the user can select the items of interest. The interface may also be capable of receiving textual input from the user so that the user can input the specific names of items and their characteristics.

The plurality of lists may include a general list that includes all of the items obtained from the user. The characteristics for which information about the items of interest are obtained may be defined by the user (e.g., user-defined). The categories of need may include a category of items needed immediately (e.g., “My Immediate” list), a category of items needed regularly (e.g., “My Regular” list), a category of items of general interest (e.g., wish list or “My Interested” list) but that not needed regularly or immediately.

The information about the characteristics of the item may also include frequency information about a frequency that the item is purchased by the user. The frequency information may be used to generate a reminder notice that is sent to the user via the network to remind the user that it may be time to purchase the item and replenish the user's supply of that item (e.g., an upcoming “deadline” at which time the supply of the item will need to be replenished). The frequency information may also be used to generate the reminder information is obtained from items associated with a category of regularly needed items (e.g., “My Regular” list). The generating of the reminder notice may include adding an entry for the item into a reminder list (e.g., “My Reminder” list).

Information may be collected about the items obtained from the user from one or more third party sites. User-selectable links to the collected information about the items may then be included in at least one of the generated lists that are presented to the user. After selection of one of these links, at least a portion of the collected information may be presented to the user via the network.

Evaluation or criteria information relating to the items (or features of items) obtained from user may also be collected (e.g., from third party sources) and stored in a database. The collected evaluation information (that is associated with a given item obtained from the user) may then be presented to the user (e.g., after selection of an appropriate link presented in the list in which the item is included) to provide advice to the user regarding the item and product related information that can be used by the user in evaluating whether or not to purchase the given item. The user may be queried (e.g., via the network) for information relating to the user's interest in the given item. This information relating to the user's interest can then be used to generate a recommendation or suggestion to the user about the item (e.g., a list of recommended products that will meet the needs of the user relating to the given item).

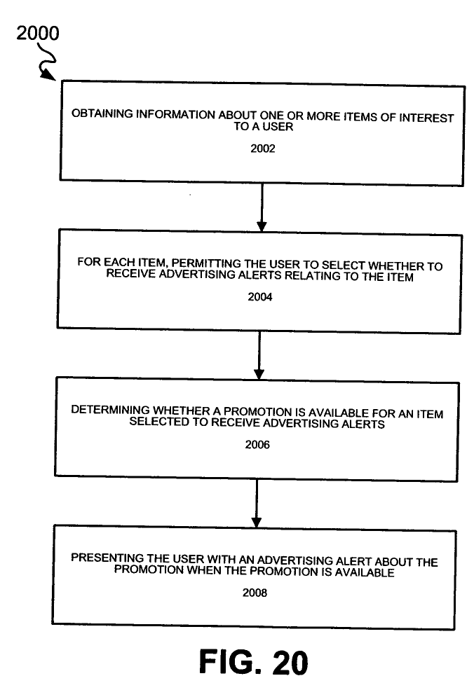

FIG. 20 is a flowchart of a process 2000 for presenting advertising alert to a user based on items of interest to the user in accordance with certain embodiments. In operation 2002, information may be obtained about one or more items of interest to a user (e.g., a buyer). In operation 2004, for each item of interest, the user may be permitted to select whether or not to receive advertising alerts and/or product-information relating to the item. In operation 2006, it may be determined whether a promotion is available for an item selected to receive advertising alerts. In one embodiment, the determination may occur at any time (e.g., whether or not the user is currently/actively accessing the service). In operation 2008, the user may be presented with an advertising alert about the promotion when the promotion is available.

The user may be permitted to specify criteria for selecting promotions in which case, the determination may also include a determination as to whether the available promotion satisfies at least a portion of the criteria specified by the user. The advertising alert may then be presented, for example, for only those promotions that satisfy the at least a portion of the criteria. The advertising alert may be transmitted to a wireless device of the user (e.g., a cell phone, a wireless PDA). The advertising alert may also be presented to the user via a network.

The determination in operation 2006 may also include registering one or more sellers with the universal network market system to permit the seller to submit promotions for goods and services associated with the seller. In such an embodiment, it may be determined whether any of the submitted promotions of the seller matches one of the items selected by the user as an item that the user is interested in receiving advertising alerts for. In such as case, the advertising alert that are actually presented to the user may be associated with at least one submitted promotion that was determined to match the item(s) submitted selected by the user. In one implementation, the user may further be provided with the option to contact the seller of the matching promotion directly via a network rather than having to go through the universal network market system.

In one implementation, one or more third party sites may be searched (e.g., via a network) for promotions that will expire within a predetermined amount of time in the future (e.g., timing-critical promotions that will expire in a short amount of time (e.g., in the near future)). Next, a determination may be made as to whether the promotion is directed to one or more of the items obtained from the user and, if so, an advertising alert may be generated and presented the user that indicates that the timing-critical promotion that will expire in the predetermined amount of time. As an option, timing-critical promotions may be generated for items that the user has chosen not to receive advertising alerts.

Third party sites may be further searched (e.g., via a network) for new update information associated with the item(s) obtained from the user. An alert may then be generated and presented the user that indicates the availability of the new update information.

In one implementation, a magazine/brochure may be generated that contains the promotions determined to be available, and wherein the magazine is presented to the user. The magazine that is generated may be an online magazine that is accessible for viewing via a network such as the Internet. As another option, the magazine may also be distributed as a hard-copy (e.g., paper) document. In any event, the magazine may also contain identifiers associated with the promotions that have been included in the magazine. These identifiers can be used when redeeming the promotion and for book keeping purposes in the universal network market system. The magazine may also includes promotions for additional recommended items (e.g., recommended ads) that are selected based on an association to the items for which promotions are determined to be available.

For each item of interest to the user, the obtained information may also include information about one or more characteristics of the item (such as, e.g., size and/or quantity of the item, a price for the item (e.g., a retail price and/or a price at which the buyer would be interested in purchasing the item), a seller, manufacture, designer and/or provider of the item (e.g., Safeway or Armani)). In such an embodiment, the determining whether a promotion is available or not may include a search for promotions that relate to the information about the one or more characteristics of the item.

The user may also be permitted to assign each item of interest to one or more relative categories of need (based on the relative need by the user for the item). The assigned items may then be organized into a plurality of item lists according to the item's assigned categories of need. These lists may be presented to the user in a user-selectable format so that the user can select and review items assigned to the same category of need in the list associated with the given category of need. As an option, the advertising alert may be presented in those lists in which the item is assigned.

In one embodiment, the promotion that is determined to be available may require that an identifier associated with the user to be disclosed when redeeming the promotion (e.g., the promotion is a private coupon). In another embodiment, the user may be permitted to forward the advertising alert to a third party who can then access the promotion utilizing the advertising alert. The user may then be assigned a credit for the access by the third party with the value of the credit being assigned based on at least a degree of relatedness of the third party to the user.

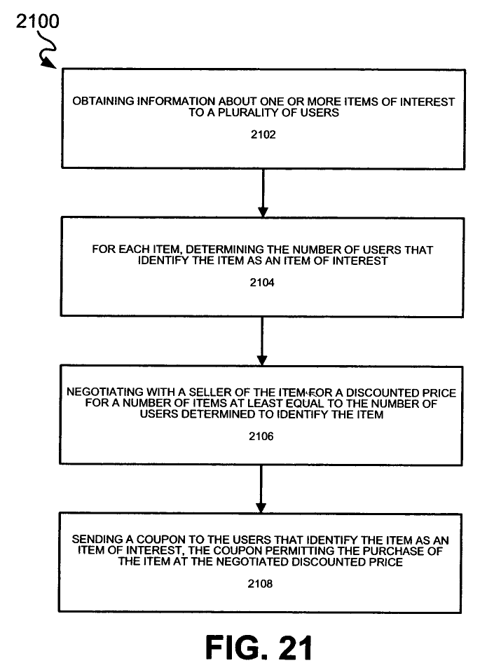

FIG. 21 is a flowchart of a process 2100 for purchasing items in accordance with certain embodiments. In operation 2102, information may be obtained about one or more items of interest to a plurality of users (e.g., a buyer). For each item, the number of users that identify the item as an item of interest may be determined in operation 2104. In operation 2106, negotiations may be conducted with a seller of the item to negotiate a discounted price based on the number of users determined to identify the item. A coupon may then be to the users that identify the item as an item of interest. This coupon permits the users to purchase of the item at the negotiated discounted price upon redemption of the coupon. The coupon may be sent to a wireless device of the users that identify the item as an item of interest. The coupon may also be sent via a network such as the Internet.

As an option, the universal network market system may purchase the number of items in bulk from the seller on behalf of the users and then sell the items directly to the users. The determination conducted in operation 2104 may be performed for a set of the items of interest that are assigned by the users into a category of items needed immediately by the users. In another embodiment, the items of interest for each user may be organized into a plurality of item lists according to assigned categories of need. These lists may then be presented to the respective user in a user-selectable format so that the user can select and review items assigned to the same category of need in the list associated with the given category of need. The coupon sent to users may be presented in the lists of the users having the item of interest (e.g., those lists that contain the item of interest).

In one implementation, users may be permitted to forward the coupon to a third party. If the third party redeems the coupon when purchasing the item associated with the coupon, the user may be assigned a credit for the redeeming of the coupon by the third party. The value of the credit may be assigned based on a degree of relatedness (e.g., the degree of separation) of the third party to the user.

In one implementation, reviews and critiques made by the users about at least one item may be collected. At least a portion of the reviews may have been made by users that are separated from each other by a predetermined degree of relatedness (e.g., degree of separation) or less (e.g., users that are linked to one another by a predetermined degree of relatedness or less (e.g., if the predetermined degree of relatedness is three degrees of separation, then users that are separated by three, two or one degree of separation would be included)). A user in the group of users that are separated from each other by the predetermined degree of relatedness may then be presented with a “linked” rating for the item based on the portion of reviews that were made by the users separated from each other by the predetermined degree of relatedness. A “general” rating for the item based on all of the reviews for the item may be presented adjacent the “linked” rating so that the user can compare the two ratings to one another.

In one implementation of a universal network market system, a process may be implemented for finding customer orientated Ads. In such an implementation, buyer's information may be obtained about one or more items of interest to a buyer. For each item, the buyer's information may comprise information identifying the item and information about one or more characteristics of the item. Seller's information may then be selected to present to the buyer according to the buyer' information.

In one embodiment, the selected seller's information may be presented to the buyer. In such an embodiment, the presenting can be in the form of text, print, audio, and video, data stream, icons or graphics images with links to host web servers. In another implementation, the presenting and receiving can be through Internet, telephone, e-mail, TV, Interactive TV, interactive voice response (IVR), voice-over IP, call center, store fronts, ATM, kiosks, any hand held device and other platform that can conduct the business. In a further implementation, the presenting can be in the form of serving the buyer the selected seller's information. In yet another implementation, the presenting can be in the form of sending the buyer the selected seller's information.

In one embodiment, selected seller's information, or the buyer's information, or seller's information may be stored in a database. In one implementation, the database may be stored centrally on a network device. In another implementation, the database may be stored locally on a network device. In a further implementation, the database may be stored distributively on network devices, or stored in a network stream.

In one embodiment, a seller's desire—which is the information about items a seller wish to sell or serve—may be received. In such an embodiment, the seller's desire may be treated as seller's information. In another embodiment, the selecting of the seller's information may be based on the buyer's information available on the database, while the buyer is using the network device or not using the network device. In a further embodiment, seller's information may be selected locally. In yet another embodiment, seller's information may be selected distributively over the network. In yet another embodiment, seller's information may be selected centrally.

In one embodiment, a computer or computing machine may select the seller's information. In another embodiment, a human being may select the seller's information manually. In a further embodiment, an easy shopping organizer (e.g., a shopping list) may be provided.

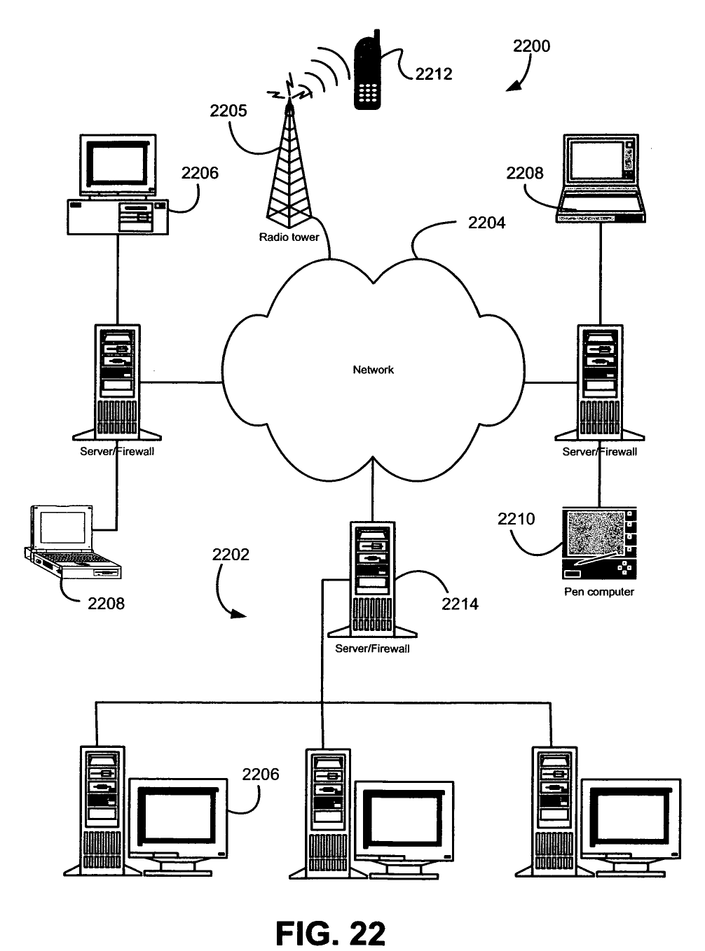

FIG. 22 illustrates a sample network system 2200 with a plurality of components 2202 in accordance with one embodiment. As shown, such components include a network 2204 which take any form including, but not limited to a local area network, a wide area network such as the Internet, and a wireless network 2205. Coupled to the network 2204 is a plurality of computers which may take the form of desktop computers 2206, lap-top computers 2208, hand-held computers 2210 (including wireless devices 2212 such as wireless PDA's or mobile phones), or any other type of computing hardware/software. As an option, the various computers may be connected to the network 2204 by way of a server 2214 which may be equipped with a firewall for security purposes. It should be noted that any other type of hardware or software may be included in the system and be considered a component thereof.

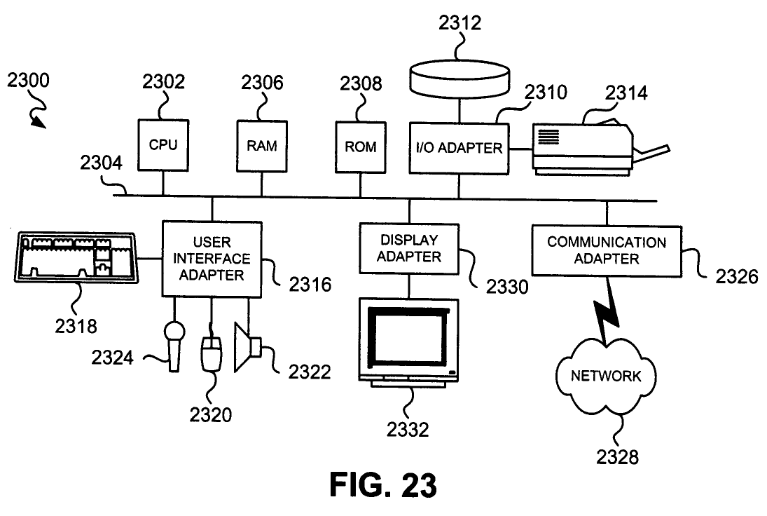

A representative hardware environment associated with the various components of FIG. 22 is depicted in FIG. 23. In the present description, the various sub-components of each of the components may also be considered components of the system. For example, particular software modules executed on any component of the system may also be considered components of the system. In particular, FIG. 23 illustrates a sample hardware configuration of a computer 2300 having a central processing unit 2302, such as a microprocessor, and a number of other units interconnected via a system bus 2304. The computer 2300 shown in FIG. 23 includes a Random Access Memory (RAM) 2306, Read Only Memory (ROM) 2308, an I/O adapter 2310 for connecting peripheral devices such as, for example, disk storage units 2312 and printers 2314 to the bus 2304, a user interface adapter 2316 for connecting various user interface devices such as, for example, a keyboard 2318, a mouse 2320, a speaker 2322, a microphone 2324, and/or other user interface devices such as a touch screen or a digital camera to the bus 2304, a communication adapter 2326 for connecting the computer 2300 to a communication network 2328 (e.g., a data processing network) and a display adapter 2330 for connecting the bus 2304 to a display device 2332. The computer may utilize an operating system such as, for example, a Microsoft Windows operating system (O/S), a Macintosh O/S, a Linux O/S and/or a UNIX O/S. Those of ordinary skill in the art will appreciate that embodiments may also be implemented on platforms and operating systems other than those mentioned. One of ordinary skilled in the art will also be able to combine software with appropriate general purpose or special purpose computer hardware to create a computer system or computer sub-system for implementing various embodiments described herein. It should be understood the use of the term logic may be defined as hardware and/or software components capable of performing/executing sequence(s) of functions. Thus, logic may comprise computer hardware, circuitry (or circuit elements) and/or software or any combination thereof.

### Expandable Platform

The universal network market system is highly scalable and is capable of accommodating many products, services, merchants, advertisers and buyers. In other words, the Shopping Expert, Shopping List, Customer-Oriented Advertisement mechanisms are highly scalable as well. Numerous commercial companies can be permitted to build Customer-Oriented Advertisements, Shopping Experts and Shopping Lists using such a scalable platform with our permission. Companies or users can submit expert solutions.

### Referral System Process

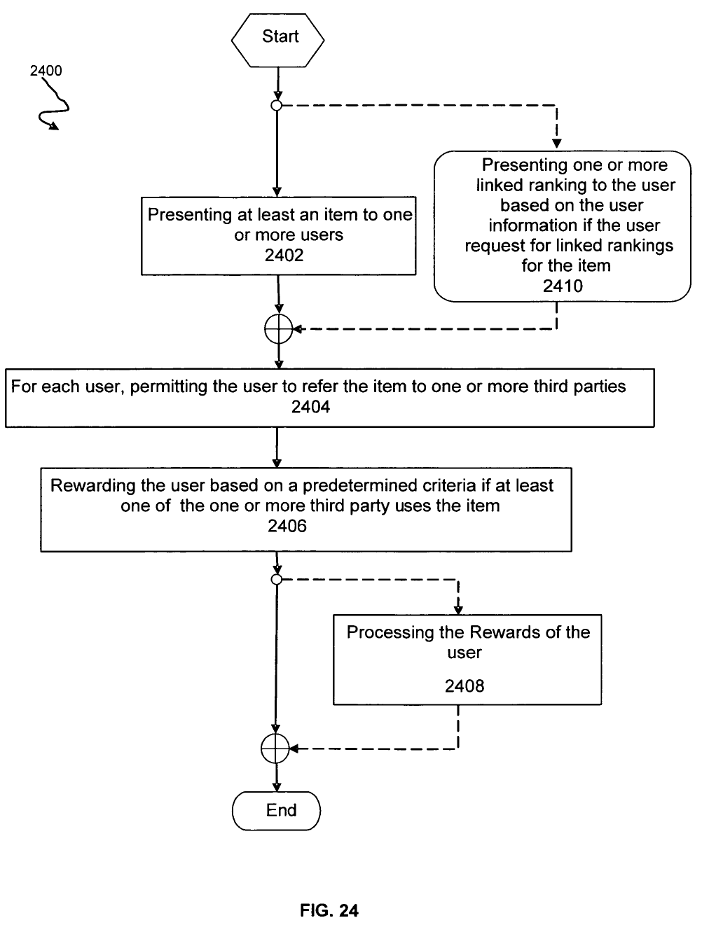

FIG. 24 is a flow chart of a process 2400 for referring items to third parties. In operation 2402, at least one item (product/service/service provider/event/promotion/advertising alert, e.g. promotion “$500 off Dell Laptop”, or service provider Lyhoo, Inc) is presented to a user. In operation 2404, for each item, the user is permitted to refer the item (e.g., Lyhoo, Inc) to one or more third parties, such as classmates of the user. The user can invite the classmates to use the service provided by Lyhoo, Inc. In operation 2406, the user will be rewarded according to a predetermined criteria if at least one of the invited third parties use the item. For example, a coupon “$500 of Dell Laptop” from Lyhoo, Inc is presented to a user but the user may not use the coupon to buy a computer. Instead, the user can entice a friend to use the coupon. If the friend uses the coupon, a reward will be given to the user or a credit will added to the user's account.

When the item is presented to the user, the item may be associated with the user's identity (e.g. driver license, user ID, or email-address). For example, the universal network market system can simply associate coupons “$500 of Dell Laptop” presented to the user with the user's email-address. Thus, when a third party uses the coupon, the universal network market system can identify the user immediately. The universal network market system permits the user to send an email to friends to invite them to join the universal network market system service. A link (associated with the user) to Lyhoo, Inc can be included in the email. Once the friend clicks on the link, a reward (such as $0.1) will be rewarded to the user. If the friend opens an account with Lyhoo, Inc., more rewards (such as $0.5) will be awarded to the user. In the case that the user identity is not associated with the item, the third party will be asked for referral information. For example, when a new user attempts to join the service of Lyhoo, Inc., Lyhoo may ask whether any person has referred the Lyhoo service to the new user.

The predetermined criteria may be based on timeliness of response. The earlier the response by a third party to using the item referred by the user results in a more generous reward to the user who made the referral, according to certain embodiments. For example, a user asks a friend to join the service of Lyhoo, Inc. $0.1 will be rewarded if the friend joins within a week and $0.01 will be rewarded if the friend joins half a year later.

The predetermined criteria may also be based on the degree of separation associated with each referral. For example, are the referrals direct referrals or indirect referrals. For example, if a user refers friend-A, the user may be rewarded with $0.1. If friend-A refers a person-B, then friend-A may be rewarded $0.1, and the user may be rewarded of $0.02. Thus, the rewards awarded to the user includes all rewards in the chain of referrals back to the user. The less distance the referral is away from the user in the chain, the more rewards the user gets.

Additional operations may be included. In operation 2408, the universal network market system may analyze the rewards presented to the user. For example, each time the user refers a person to the promotion “$500 off DELL laptop”, the user gets a reward. A credit can be added to the user's account. The universal network market system can sum up all credits and decide whether to reward the user a monetary award or some non-monetary prize.

In operation 2410, the user may want to provide more information to a friend about DEVIL laptop since public opinion about the laptop is bad. The user can obtain the friend's demographic information. For example, the demographic information may be “Fancy game player, age 21, using high speed internet”. Using this demographic information about the friend, the universal network market system can provide a linked ranking (from persons of similar demographic information) for the DEVIL laptop. The friend may then be convinced that the DEVIL laptop is expensive but is worth the expense and decides to make a purchase.

### Linked Rating Process

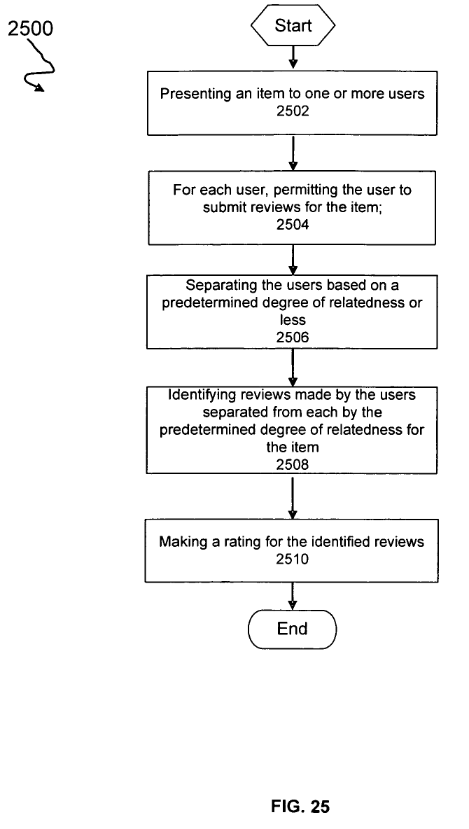

FIG. 25 is a flowchart of a process 2500 for presenting linked ranking. In operation 2502, at least one item (product/service/service provider/event/promotion/advertising alert, e.g. Sony Digital Camera or DEVIL laptop) is presented to a plurality of users. In operation 2504, for each user, the user is permitted to submit reviews for the item. In operation 2506, the users are separated based on a predetermined degree of relatedness of less (e.g. high school student, scientist). In operation 2508, the operation identifies the reviews made by the users separated from each by the predetermined degree of relatedness for the item (for example, reviews on Sony Digital Camera from high school students, reviews on Sony Digital camera from scientists). In operation 2510, a rating is made for the identified reviews. For example, the universal network market system may average the reviews on Sony Digital Camera from high schools students, average the reviews on Sony Digital Camera from scientists, average the reviews on DEVIL laptop from high schools students, and average the reviews on DEVIL laptop from scientists. It is no surprise that both high school students and scientists give a high score for Sony Digital Camera. The high school students give a low score for DEVIL laptop (due to sky-high price of $10,000) while the scientists give a high score for DEVIL laptop (for its high performance).

The universal network market system may receive a user's information including identification of the user, payment information such as credit card number, shipment information, demographic information, and the user's specific information (e.g. user needs) in a particular situation. The universal network market system may receive and store additional information for users using various computer systems. The universal network market system stores the received additional information in association with the user. Such information can be used to separate users based on a predetermined degree of relatedness.

### Presenting User Needs Oriented Promotions

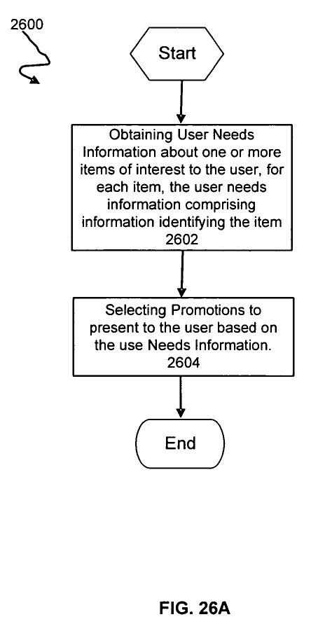

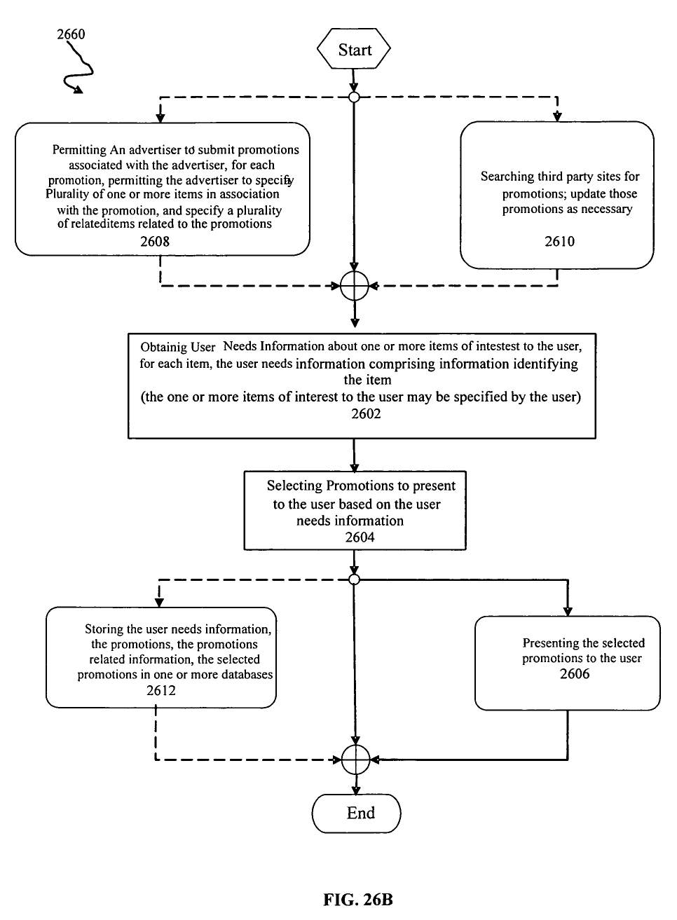

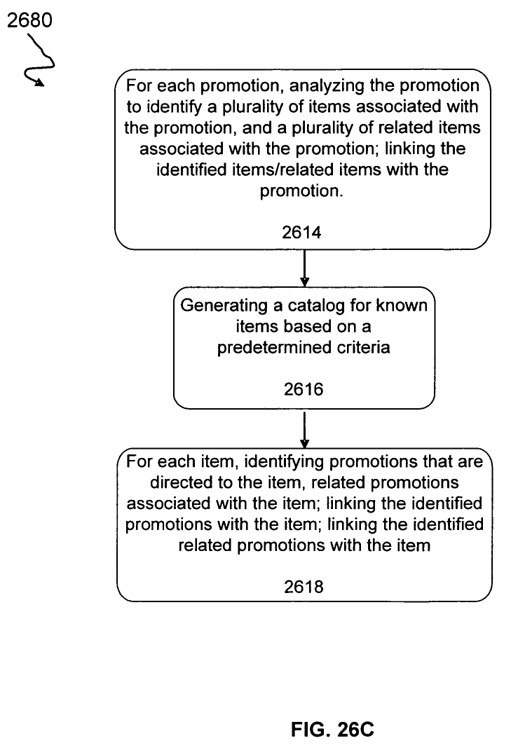

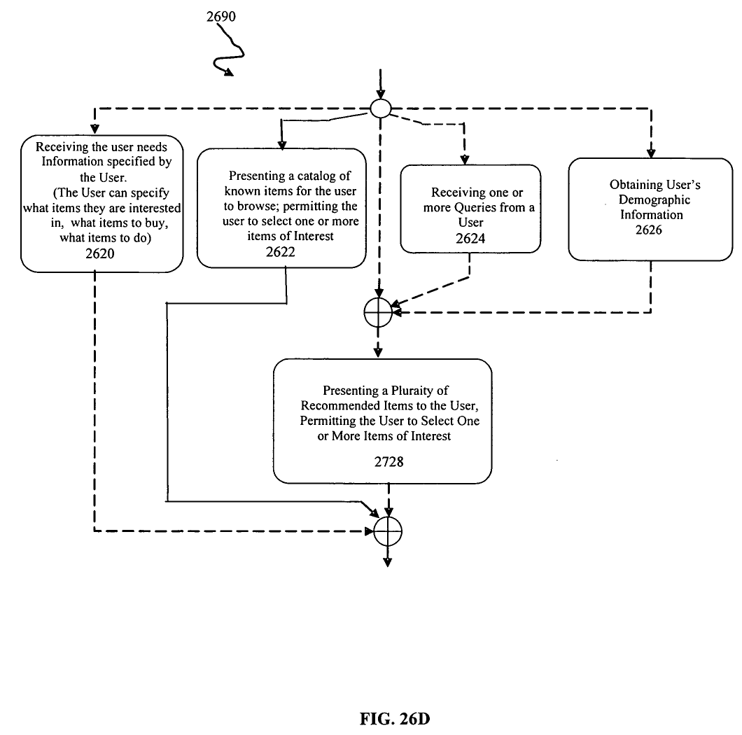

FIG. 26A-26D are flowcharts that illustrate a process for presenting user needs oriented promotions. FIG. 26A is shows a process 2600 for selecting user oriented promotions. In operation 2602, information on “user needs” may be obtained on one or more items of interest to the user (e.g., a buyer). The user can specify items of interest (e.g. information about car), specify tasks that the user would like to perform (e.g., skiing), specify items to buy (e.g., car), specify items to join (e.g. event of parade) and so on. In operation 2604, the process selects promotions based on the “user needs” information. The selection includes selecting those promotions associated with the items specified by the user (or based on the user needs information). The selection of the promotions may occur at any time (e.g. whether or not the user is currently accessing the service).

Promotions are used to advertise goods or services or events. It is clear that a promotion is directed to one or more items. For example, the promotion, “$500 of DELL laptop computer” is directed to laptops, computers, or DELL laptop computers. To illustrate, when a user specifies that he would like to purchase a monitor, the universal network market system simply chooses those promotions stored on a database 230, for example, that are associated with “monitor.”

The user may be permitted to specify criteria, such as one or more characteristics about an item, the time frame for receiving a promotion, for selecting promotions. In such a case, the selection process may also include a determination as to whether the available promotion satisfies at least a portion of the criteria specified by the user. Additional operations may be included.

FIG. 26B is a flow chart of a process 2660 for presenting user oriented promotions. In operation 2606, the selected promotions are presented to the user. For each item of interest, the user may be permitted to select whether or not to receive promotions related to the item. If the universal network market system considers a promotion valuable to the user, the universal network market system may present the promotion to the user even if the user chose not to have any advertising alert sent to him. If the promotion may expire within a predetermined amount of time in the near future, or the promotion is in limited supply, an advertising alert may be presented to the user.

The presentment can be in the form of serving the user the selected promotion (e.g. presented in the user's shopping organizer, show the selected promotion to the user on a television). In yet another implementation, the presentment can be in the form of sending the user the selected promotion (e.g. sending a promotion magazine). The presentment of selected promotions may occur at any time (put the selected promotions in the user's shopping organizer (e.g., whether or not the user is currently actively accessing the service). The promotions may be transmitted to a wireless device of the user (e.g. a cell phone, a wireless PDA, etc.). The promotions may also be presented to the user via a network. The presenting can be in a form selected from the group comprising text, print, audio, and video, data stream and icons or graphics images with links to host web servers.

While the user needs information can be obtained from one client device, the selected promotions may be presented through another device. For example, the user can specify to buy a BMW car and put the item (BMW car) in the shopping organizer through one computer. The promotions on the car, particularly promotions on BMW car can be presented to the user through a television or presented to the user through a playstation portable (PSP).

In operation 2608, the process may also include permitting advertisers to submit promotions associated with the advertiser. In such embodiments, the advertiser can specify a plurality of items in association with the promotion, and a plurality of related items related to the promotion. The specified items will be linked with the promotion. The specified related items will be linked with the promotion separately. In operation 2610, third party sites may be further searched (e.g. via a network) for promotions. The universal network market system may update such searched promotions as necessary. In operation 2612, the user needs information, the promotions, the promotions related information (e.g. items, related items), certain selected promotions, or a combination thereof may be stored in one or more databases. Accordingly, the promotion selection process may occur at any time (e.g., whether or not the user is currently actively accessing the service).

In one implementation, the database may be stored centrally on a plurality of network devices. In another implementation, the database may be stored locally on a plurality of client devices. In other implementations, the database may be stored distributively on a plurality of network devices, or stored in a network stream. Accordingly, the promotion selection process may occur centrally on a plurality of network devices, locally on a plurality of client devices, or distributively over the network devices. The presentment may occur at any time (e.g. whether or not the client device can communicate with a third party via a network). The user can check the promotions on a playstation portable (PSP) while waiting in the airport, for example.

The user may also be permitted to assign each item of interest to one or more related categories of need (based on the need by the user for the related item). The assigned items may then be organized into a plurality of item lists according to the item's assigned categories of need. These lists may be presented to the user in a user-selectable format so that the user can select and review items assigned to the same category of need in the list associated with the given category of need. As an option, the selected promotions may be presented in those lists in which the item is assigned. A machine (e.g. computer machine) or a human being can perform the selection process.

FIG. 26C is a flow chart of a process 2680 for pre-processing the promotions. The pre-processing of promotions can facilitate and speed up the selection process. In operation 2614, for each promotion, analyzing the promotion to identify a plurality of items or related items for the promotion is performed, and linking the identified items or related items with the promotion is performed. In operation 2616, a catalog is generated for known items based on predetermined criteria (e.g. location, manufacturer, size, taste). An item can be associated with one or more categories. In operation, 2618, for each item, known promotions directed to the item or known related promotions associated with the item are identified. Linking the identified promotions with the item, and linking the identified related promotions with the item separately are also performed.

The universal network market system may use this pre-process for generating a catalog of known promotions. The promotions are categorized based on the items, and a sub-category is generated for the related promotions associated with the item. The sub-category is linked to “the item category”. Once the universal network market system obtains user needs information from a user, for each item appearing in the user needs information, the universal network market system simply selects those promotions and related promotions linked with the item (for example, it selects the promotions or related promotions under the category of the item). In case no such pre-process has been performed, in order to select promotions for an item appearing in the user needs information, the universal network market system needs to determine whether there are any promotions associated with the item. For each promotion, the universal network market system determines whether the promotion is associated with the item, and determines whether the promotion is a related promotion of the item.

Similarly, at least one advertiser can specify promotions associated with targeted items (items directed by the promotions). The universal network market system can select users who have an interest in the targeted items. Those selected users are the targeted users (potential buyers) that are the most desired by advertisers.

FIG. 26D is a flow chart of a process 2690 for obtaining user needs information. In operation 2620, the user directly specifies one or more items of interest (items of interest, items to buy, items to do and so on). The universal network market system receives the specified information on items of interest from the user. In operation 2622, an electronic version of a catalog that lists known items (or things). A user, who is a potential purchaser, may browse through the catalog using a browser and select various items of interest. The selected items maybe moved to a “Shopping Organizer”. In operation 2624, a user may perform queries on one or more items, and decide whether the queried items are items of interest once the user is provided more information by the expert (machine or human being). In operation 2628, user's information (e.g. demographic information, shopping behavior, task of interest such as “to start a company”) is obtained. In operation 2628, based on the user's information or query, or task of interest to the user, the expert of universal network market system presents a plurality of recommended items for the user to browse. The user can then choose items of interest. In case, little or no information is obtained from the user, the most popular items will be recommended.

The “user needs” information may be obtained from the user by presenting to the user, an interface capable of receiving input from the user. In certain embodiments, various different means can be used to obtain the user's information. For example, an interface may receive audio input from the user, receive one or more keys strokes by the user, receive one or more button activations on a remote control device (e.g. television remote control) caused by the user, receive selections using any pointing device effected by the user, or receive textual input from the user.

The universal network market may even obtain “user needs” information on a household by household basis. A person (e.g. salesperson, our registered users) may visit homes, help users identify “user needs” (items of interest to the user), and obtain “user needs” information from users. A standard punch card listing a catalog may be sent to homes (with the homeowner's permission). Users can select the items on the punch card, then use a machine (computer machine) to scan the punch card, or mail the punch card back to the universal network market system.

### Presenting User Oriented Promotions

In many situations, a user may not know how to perform a task. For example, a new 25 year-old graduate gets a new idea and wants to start a company. The new graduate may not have enough knowledge to start a company. He may not know the importance of patents, for example. Thus, promotions on patent books, legal services on patent may have little significance to him.

In other situations, a user may not be able identify the task he needs to perform in order to achieve a given objective. For example, a new immigrant to USA may not know he needs to buy life insurance, and health insurance. Thus, promotions on life insurance and health insurance may have little significance to him.

Tasks, such as skiing, hiking, are manageable projects. However, bigger task (including big events) are complicated and may need to be divided into sub-tasks. For example, we can divide the task, “to start a company” into “get a idea”, “patent the idea if new”, “incorporate the company”, “build up a team”, “develop products”, etc. The sub-task “build up a team” may be divided into “find a CTO”, “find a CEO”, and “find engineers”.

The universal network market system attempts to understand the user, identify and obtain tasks of interest to the user. For each task, the universal network market system identifies the expert solutions for the task, identifies the items (product/service) necessary to complete the task, links the identified items to the task, and presents promotions associated with the identified items to the user. Thus, the promotions are user-task oriented and thus are likely to gain more attention from the user.

Expert solutions may include steps for performing a task, answers to questions, recommendations, recipes and so on. The system expert can be a human being or an expert system (machine).

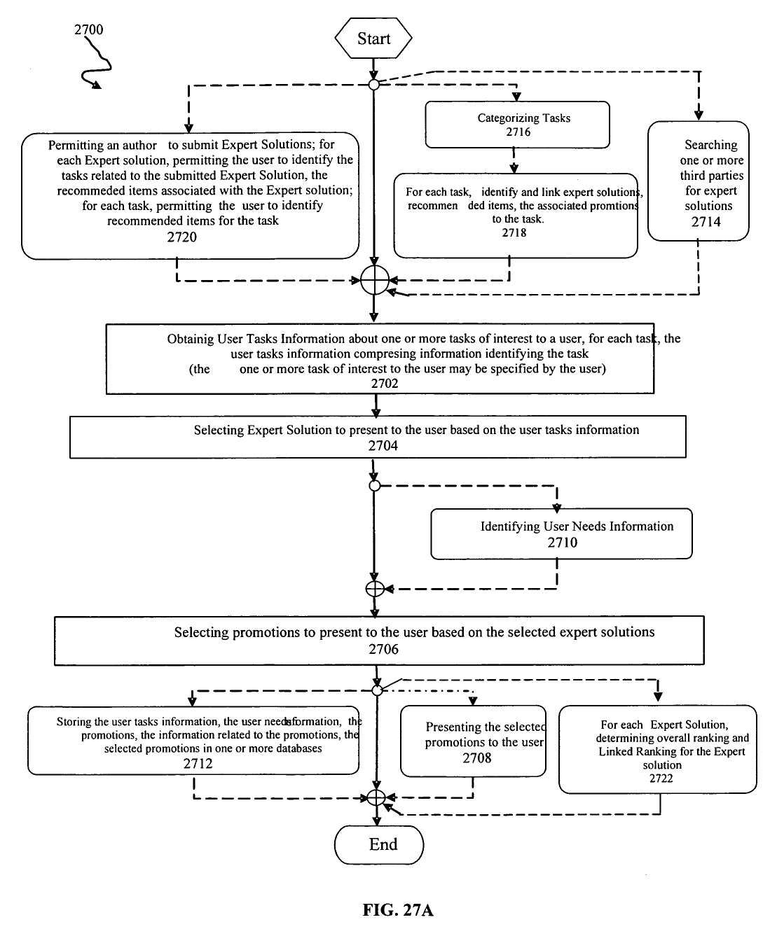

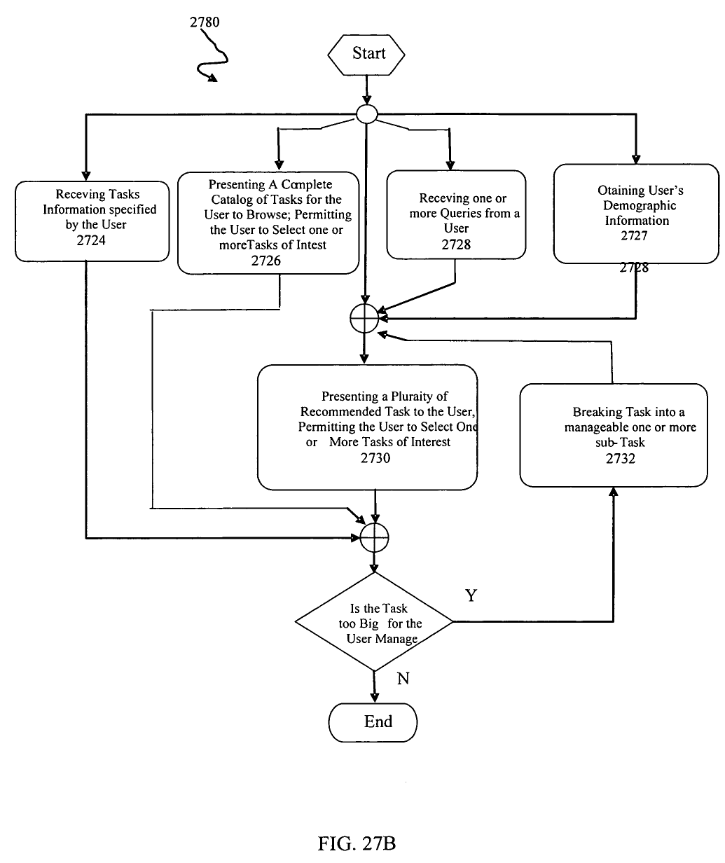

FIG. 27A-27B are flowcharts of a process for presenting user-task oriented promotions. In operation 2702 of FIG. 27A, “user task” information may be obtained about one or more tasks of interest to the user. The tasks of interest may be specified by the user. For example, the user can specify major tasks of interest (e.g. to start a company), or specify minor tasks (e.g., product release or skiing). In operation 2704, the process selects expert solutions to present to the user based on the “user task” information. The selection includes selecting expert solutions associated with the tasks specified by the user (or based on “user task” information). The expert solution may recommend a plurality of items for accomplishing the task. The selection of expert solutions may occur at any time (e.g. whether or not the user is currently actively accessing the service). In operation 2706, promotions will be selected for presenting to the user. The selection of promotions includes selecting promotions directed to those items associated with the selected expert solutions. For example, in order to start up a company, the universal network market system may identify the task “Patent the idea if new”. The expert solutions for “Patent the idea” will be identified. The expert solutions may suggest books such as “Patent it yourself” or may suggest the services of law firms such as “Perkins Coie L.L.P.”

In operation 2708, the selected promotions are presented to the user. In operation 2710, the expert solution will recommend a plurality of items to accomplish the task. The user can view the recommended items and then specify items of interest from the plurality of items. In turn, “user needs” information (items of interest) is identified. Promotions can be selected, accordingly. More accurate promotions can be presented to the user, accordingly. In operation 2712, the “user task” information, user needs information, the promotions, the promotions related information (e.g. items, related items), the selected promotions, or a combination thereof may be stored in one or more databases. Accordingly, the selection process may occur at any time (e.g., whether or not the user is currently actively accessing the service).

The user may also be permitted to assign each task of interest to one or more relative categories of action based on predetermined criteria (such work, life, sport, or urgent and any-time). The assigned tasks may then be organized into a plurality of task lists according to the task's assigned categories of action. These lists may be presented to the user in a user-selectable format so that the user can select and review tasks assigned to the same category of action in the list associated with the given category of action. As an option, the selected promotions may be presented in those lists in which the task is assigned. A machine (e.g. computer machine) or a human being can perform the selection process.

In operation 2714, third party sites may be further searched (e.g. via a network) for expert solutions. The universal network market system may update those searched expert solutions as necessary. In operation 2716, a catalog can be generated for known tasks based on predetermined criteria (e.g. life, work, education). A task can be associated with one or more category.

In operation 2718, for each task, an expert may identify expert solutions known for the task, and link the identified solutions with the task. The expert may also identify the recommended items from the identified solutions, link the recommended items to the task and then link promotions directed to the recommended items with the task. The universal network market system may identify and link relative promotions to the task. Similar to related items, the universal network market system can define “match” task as related tasks. The universal network market system can identify the related tasks for the task at hand, then identify the promotions associated with the related tasks, and then link those identified promotions with the task.

In operation 2720, an author (the user who submits expert solutions) is permitted to submit expert solutions. For each expert solution, the user is permitted to identify the tasks related to the submitted expert solution, identify the recommended items from the submitted expert solutions, and link the recommended items to the task (directed by the submitted expert solution). The universal network system then link promotions (directed to the recommended items by the author) with the task. Such pre-processing of the promotions/task can facilitate and speed up the selection process.

Similarly, at least one advertiser can specify promotions associated with targeted items (items directed by the promotions). The universal network market system can select users who have an interest in the targeted items. Those selected users are the targeted users (potential buyers) that are the most desired by advertisers.

In operation 2722, users are permitted to submit reviews for the expert solution. The Expert of universal network market system may submit reviews for the expert solutions. For each expert solution, overall ranking and linked ranking will be determined. Such rankings are available to users (e.g. posted on the Web-site).

The process 2690 of FIG. 26D for obtaining items of interest to the user can be accommodated to obtain tasks of interest to user. An additional operation 2732 can be included to break-up complicated task into sub-tasks in order to find expert solutions for the sub-task.

In operation 2724, the user directly specifies one or more tasks of interest. The universal network market system receives the tasks of interest from the user. In operation 2726, an electronic version of a catalog that lists known tasks or things can be presented to the user. The user, who may be a potential purchaser, may browse through the catalog using a browser and may select various tasks of interest (e.g. task to accomplish, such as “a high school student wants to be a doctor”). The selected tasks may be moved to an “Action Organizer”. In operation 2728, a user may submit queries about one or more tasks, and may decide whether the queried tasks are tasks of interest once the user is provided more information by the expert (machine or human being). In operation 2727, user's information (e.g. demographic information, shopping behavior, task of interest”) is obtained. In operation 2730, based on the user's information or query, or task of interest, the expert of universal network market system presents a plurality of recommended tasks for the user to browser. For each task of interest to user, the universal network market system may identify the related task as the recommended tasks. The user can choose tasks of interest. In case, little or no information is obtained from the user, the most popular tasks (e.g. how to get a good job) can be recommended.

### Marketing Method

For marketing purposes, the universal network market system may make all the expert solutions open for viewing to all users. Alternatively, the universal network market system may make only some expert solution open to all users, while reserving some other expert solutions for qualified users only.

For example, the universal network market system may create a recipe for an “Analog Circuit Design Step by Step”. The recipe is divided into ten sections. The first two sections may be made available to everyone, while the universal network market system may reserve the rest of the eight sections only for qualified users. The universal network market system may allows any user to view the first two sections of recipe. The universal network market system may require a user to refer a pre-determined number of friends (e.g. 10 friends) to join the service of the universal network market system in order to read the reserved sections of the recipe.

### Generating an Expert Platform

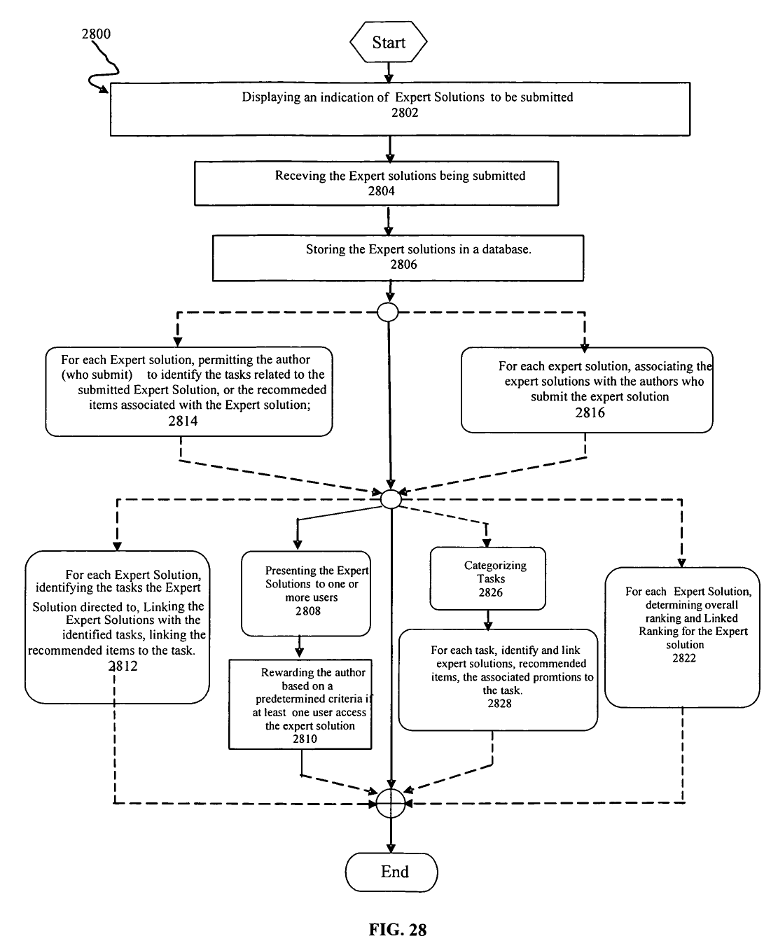

FIG. 28 is a flow chart of a process 2800 for generating an expert platform. In operation 2802, an indication is displayed for expert solutions to be submitted. In operation 2804, the universal network market system receives the submitted expert solution. In operation 2806, the expert platform stores the expert solutions in one or more databases.

In operation 2808, the universal network market system presents the submitted expert solutions to one or more users. The presentment can be in the form of web-page posting. Further, the presentment can be in a form selected from the group comprising text, print, audio, and video, data stream and icons. In operation 2810, for each expert solution, the author(s) of the expert solution is rewarded based on predetermined criteria. The predetermined criteria can be the number of users viewing the expert solution, the ranking (public ranking, linked ranking) of the expert solution and so on. In operation 2812, for each expert solution, tasks to which the expert solution is directed are identified. The universal network market system links the expert solution to the identified tasks. The universal network market system identifies the recommended items to accomplish the task and links the recommended items to the task.

In operation 2814, for each expert solution, the author is permitted to identify the tasks directed by the submitted expert solution, and to recommend items to accomplish the task. The universal network market system may link the submitted expert solution to the identified tasks. The universal network market system may link the recommended items to the identified tasks separately. In operation 2818, for each expert solution, the universal network market system associates the expert solutions with the authors who submit the expert solutions.

In operation 2826, a catalog is generated for known tasks based on predetermined criteria (e.g. life, work, education). A task can be associated with one or more categories. In operation 2828, for each task, an expert may identify expert solutions that are known for the task, and link the identified solutions with the task. The expert may also identify the recommended items from the identified solutions, link the recommended items to the task and then link promotions directed to the recommended items with the task. In operation 2822, users are permitted to submit reviews for the expert solution. The expert of the universal network market system may submit reviews for the expert solutions also. For each expert solution, overall ranking and linked ranking can be determined. Those ranking can be made available to users (e.g. posted on the Web-site).

### An Expert Platform

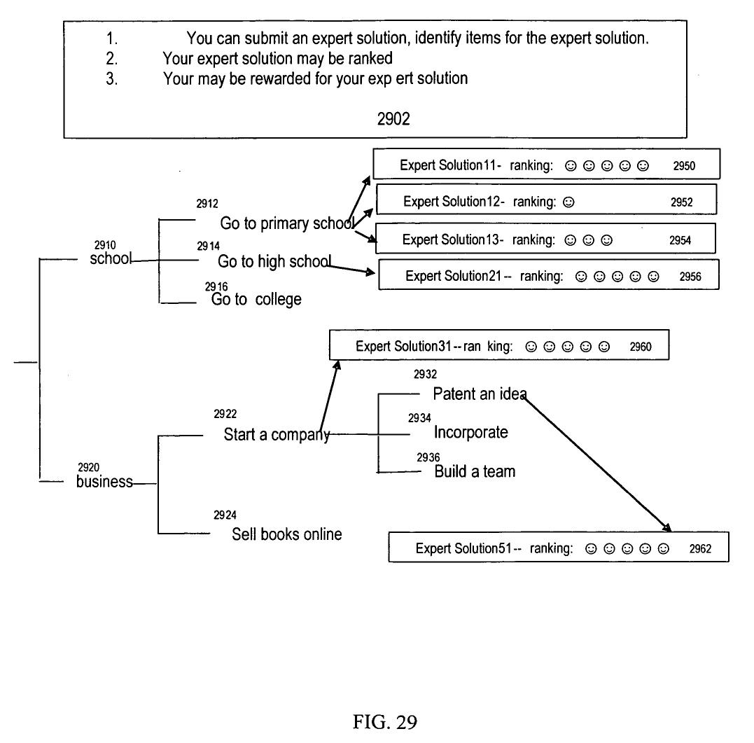

FIG. 29 is a non-limiting sample expert platform. Instruction 2902 indicates that at least one author (the user who submit the expert solution) can submit expert solutions. The author can recommend items to accomplish the task directed by the expert solutions owned by the author. The submitted expert solution may be ranked. The author may be rewarded for the submitted expert solution based on predetermined criteria. The predetermined criteria can be the number of persons accessing the expert solution and or the ranking of the expert solution. The ranking may include public ranking and linked ranking.

The tasks are categorized based on school 2910, and business 2920. The category of school 2910 includes the tasks of “go to primary school 2912”, “go to high school 2914”, and “go to college 2916”. The category of business includes the tasks of “start a company 2922” and “sell books on line 2924”. The task, “start a company 2922” is divided into “patent the idea 2932”, “incorporate 2934”, and “build a team 2936”.

There is no any expert solution linked to (specifically for) the tasks of “go to college 2916”, “incorporate 2934”, “build a team 2936”, and “sell books on line 2924”. “Go to primary school 2912” has three expert solutions 2950, 2952, 2954. Expert solution 2950 has the highest ranking, while expert solution 2952 has the lowest ranking. “Go to high school 2914” has one expert solution 2956, which has the highest ranking. “Start a company 2922” has one expert solution 2960. It is a complicated task, and has an expert solution associated with it. “Patent an idea 2932” has one expert solution 2962, which has the highest score.

Embodiments of the invention may be implemented using computer programming or engineering techniques including computer software, firmware, hardware or any combination or subset thereof. Any such resulting program—having computer-readable code—may be embodied or provided in one or more computer-readable media, thereby making a computer program product (e.g., an article of manufacture) implementation of one or more embodiments described herein. The computer readable media may be, for instance, a fixed drive (e.g., a hard drive), diskette, optical disk, magnetic tape, semiconductor memory such as for example, read-only memory (ROM), flash-type memory, etc., and/or any transmitting/receiving medium such as the Internet and/or other communication network or link. An article of manufacture containing the computer code may be made and/or used by executing the code directly from one medium, by copying the code from one medium to another medium, and/or by transmitting the code over a network. In addition, one of ordinary skill in the art of computer science may be able to combine the software created as described with appropriate general purpose or special purpose computer hardware to create a computer system or computer sub-system embodying embodiments or portions thereof described herein.

We claim:

1. A method for advertising, the method comprising the computer-implemented acts of:
obtaining information, from a user, on at least one task that is of interest to said user when said user is online; and
selecting advertisements based on said information, wherein said selected advertisements are for presenting to said user.

2. The method of claim 1, further comprising:
selecting at least one expert solution directed to said at least one task based on said information;
identifying items for implementing said at least one expert solution, wherein said items comprise one or more of products, and services; and
presenting said items to user for selection.

3. The method of claim 1, wherein presenting advertisements includes selecting advertisements based on selected items selected by said user when said user is presented with a list of items identified for accomplishing said at least one task.

4. The method of claim 1, wherein selecting advertisements includes selecting advertisements based on said at least one task.

5. The method of claim 1, wherein selecting advertisements includes selecting advertisements based other tasks that are related to said at least one task.

6. The method of claim 4, further comprising selecting up-selling type advertisements.

7. The method of claim 4, further comprising selecting cross-selling type advertisements.

8. The method of claim 1, wherein selecting advertisements occurs dynamically while said user remains online.

9. The method of claim 1, further comprising storing, on a database, said information on said at least one task, identification of at least one expert solution directed to said at least one task, and identification of items for implementing said at least one expert solution, demographic information on said user, and user input.

10. The method of claim 9, wherein selecting advertisements occurs when said user is offline by analyzing information stored on said database.

11. The method of claim 1, wherein obtaining information on said at least one task further comprises allowing said user to describe said at least one task.

12. The method of claim 1, wherein obtaining information on said at least one task further comprises providing a catalog of tasks and said user selects said at least one task from said catalog.

13. The method of claim 1, wherein obtaining information on said at least one task further comprises:
receiving one or more queries from said user;
obtaining demographic information on said user; and
recommending, to said user for selection, a plurality of tasks based on said one or more queries in view of said demographic information.

14. The method of claim 1, wherein obtaining information on said at least one task further comprises:
providing a list plurality of expert solutions on a variety of tasks to said user;
permitting said user to select an expert solution that is of interest to said user;
identifying said at least one task based on an expert solution selected by said user.

15. The method of claim 14, further comprising:
permitting a registered user to obtain a complete view of said user selected expert solution.

16. The method of claim 14, further comprising:
permitting an unregistered user to obtain a partial view of said user selected expert solution, wherein said unregistered user is permitted to obtain a complete view of said user selected expert solution when said unregistered user recruits a pre-determined number of users to register.

17. A system for advertising, the system comprising:
one or more analysis engines for analyzing user queries, user demographic information, user input for identifying one or more tasks that are of interest to a user;
a relational database for managing information on said user queries, said user demographic information, said user input and advertisement information; and
logic for selection of particular advertisements that are based on said identified one or more tasks.

18. The system of claim 17, further comprising:
a provisioning mechanism for providing expert solutions to said user;
logic for identifying sub-tasks and related tasks associated with said identified one or more tasks that are of interest to said user; and
logic for identifying advertisements associated with said sub-tasks and said related tasks.

19. A system for advertising, the system comprising:
means for identifying one or more tasks that are of interest to a user;
means for gathering information needed for selecting advertisements based on said identified one or more tasks; and
means for analyzing said gathered information for selecting advertisement to present to said user.

20. The system of claim 19, further comprising:
means for providing expert solutions to said user; and
means for identifying sub-tasks and related tasks associated with said identified one or more tasks that are of interest to said user.
